(19) United States
(12) Patent Application Publication
(10) Pub. No.: US 2011/0081591 A1
(43) Pub. Date: Apr. 7, 2011

(54) METHOD FOR THE PRODUCTION OF AN ELECTROCHEMICAL CELL

(75) Inventors: Joachim Scherer, Ulm (DE); Raimund Stroebel, Ulm (DE); Thomas Schmidt, Moerfelden-Walldord (DE)

(73) Assignee: BASF SE, Ludwigshafen (DE)

(21) Appl. No.: 12/996,507

(22) PCT Filed: Jun. 5, 2009
(86) PCT No.: PCT/EP2009/004041

§ 371 Date: Dec. 6, 2010

(30) Foreign Application Priority Data
Jun. 5, 2008 (EP) 08010251.0

(51) Int. Cl. H01M 8/04; H01M 8/10; H01M 8/24

(52) U.S. Cl. 429/457; 429/535; 429/480

(57) ABSTRACT

The present invention relates to a new method for the production of electrochemical cells, in particular individual cells for fuel cells and stacks as well as components and semi-finished parts required for this purpose. The gas diffusion layer is fixed on the bipolar plate by constructional measures and thus an improved positioning of the individual components of an electrochemical cell, in particular an individual cell for fuel cells is achieved. The method according to the invention allows for a flexible production. The semi-finished parts according to the invention are valuable, storable intermediate products which substantially reduce the lead times in the production of electrochemical cells, in particular individual cells for fuel cells.

The present invention relates to a new method for the production of electrochemical cells, in particular for electrolysers, electrochemical compressors and individual cells for fuel cells and stacks as well as components and semi-finished parts required for this purpose.

Electrochemical cells, in particular fuel cells have been known for a long time and represent an environmentally friendly source of electric energy and heat. Although the development of fuel cells is already well advanced and first prototypes and small series are available on the market, the production of fuel cells, in particular of individual cells for fuel cells and stacks still poses a big challenge. The currently chosen production methods are suitable for the commercial launch, but yet to be improved for large-scale production, in particular to achieve the cost objectives aimed for. Due to the complex multi-parameter system of fuel cells, the required components and their production have to be precisely aligned.

Nowadays sulphonic acid-modified polymers are almost exclusively used as proton-conducting membranes in polymer electrolyte membrane (PEM) fuel cells. Here, predominantly perfluorinated polymers are used. Nafion™ from DuPont de Nemours, Willmington, USA is a prominent example of this. For the conduction of protons, a relatively high water content is required in the membrane, which typically amounts to 4-20 molecules of water per sulphonic acid group. The required water content, but also the stability of the polymer in connection with acidic water and the reaction gases hydrogen and oxygen restricts the operating temperature of the PEM fuel cell stacks to 80-100° C. Higher operating temperatures cannot be implemented without a decrease in performance of the fuel cell. At temperatures higher than the dew point of water for a given pressure level, the membrane dries out completely and the fuel cell provides no more electric energy as the resistance of the membrane increases to such high values that an appreciable current flow no longer occurs.

If the polymer electrolyte membrane at the same time contains the catalyst or electrode, respectively, one speaks of a membrane electrode assembly (MEA). A MEA based on the technology set forth above is described, for example, in U.S. Pat. No. 5,464,700.

Due to system-specific reasons, however, operating temperatures in the fuel cell of more than 100° C. are desirable. The activity of the catalysts based on noble metals and contained in the membrane electrode assembly (MEA) is significantly improved at high operating temperatures.

Especially when the so-called reformates from hydrocarbons are used, the reformer gas contains considerable amounts of carbon monoxide which usually have to be removed by means of an elaborate gas conditioning or gas purification process. The tolerance of the catalysts to the CO impurities is increased at high operating temperatures.

Furthermore, heat is produced during operation of fuel cells. However, the cooling of these systems to less than 80° C. can be very complex. Depending on the power output, the cooling devices can be constructed significantly less complex. This means that the waste heat in fuel cell systems that are operated at temperatures of more than 100° C. can be utilised distinctly better and therefore the efficiency of the fuel cell system can be increased.

To achieve these temperatures, in general, membranes with new conductivity mechanisms are used. One approach to this end is the use of membranes which show ionic conductivity without employing water. The first promising development in this direction is set forth in the document WO96/13872.

Further high-temperature fuel cells are disclosed in JP-A-2001-196082 and DE 10235360 in which the sealing systems of the electrode membrane assembly are specifically examined.

Typically, the polymer electrode membrane or the MEA, respectively, have a thickness of 10 to 1000, preferably 10 to 500 μm. This means that the membrane or MEA are extremely floppy and therefore provide handling problems during assembly. In order to overcome these problems, they are usually embedded into frames which moreover are provided with positioning tools. To produce an individual cell for fuel cells or a stack, the membrane electrode assemblies mentioned above are generally connected with planar bipolar plates which include ducts for a gas stream which were milled, moulded or embossed into the plates, the channels of the flow field.

Bipolar plates with integrated channels of the flow field for the production of individual cells for fuel cells or stacks have already been known for a long time. However, when installing the bipolar plates, it is important to provide sufficient gas/media leak tightness. To this end, the bipolar plates are sealed by means of gaskets towards the back of the gas diffusion layer (GDL) or gas diffusion electrode (GDE) (cf. DE 10 2005 046461) in some cases referred to as a special frame (cf. EP-A-1437780).

Another approach to seal the bipolar plate towards the gas diffusion layer or gas diffusion electrode is to already design parts of the bipolar plate in the construction process as gaskets (cf. EP-A-1612877 and EP-A-0774794) or to design the gasket as an integral part of the gas diffusion layer. Such a solution is described in EP-A-1296394. In the process, liquid sealing material penetrates the boundary area of the gas diffusion layer and solidifies in a subsequent step.

The aforementioned gasket or special frame, respectively, besides providing for sealing between the bipolar plate and the MEA also locally increases the thickness in the surroundings of the GDL/GDE. Often, relatively hard materials such as PTFE are used for this purpose. In order to improve their sealing behaviour, an additional elastic gasket can be provided on this gasket or frame, respectively. In the subsequent production of the individual cell for fuel cells or the stack, the arrays are screwed together and thus sealed.

It has been found that these production methods lead to problems, in particular when compressing the bipolar plate and the finished membrane electrode assembly. Due to the different compressibilities of the materials or different tolerances, leaks are noted which even by means of a combination of a hard gasket (special frame) and a resilient gasket cannot be compensated. Additionally, a production process in accordance with the above-mentioned principle includes the handling of many geometrical layers and their positioning in respect to each other. To this end, so-called positioning tools or adjusting tools are used as supporting measures which make the production process more complex—and thus more expensive. The main reason for this is that membrane and GDL/GDE have to be tailored larger than actually necessary with respect to their function because of positioning tolerances during assembly. Moreover, if an additional resilient gasket as described above is used, this constitutes an additional expense. The frame facilitating the handling of the membrane is not necessary from a purely functional point of view, neither.

It was now found that above problems can be avoided when the production is not performed by means of compressing the bipolar plate and the finished membrane electrode assembly, but starting from a gas diffusion layer or electrode inserted into or fixed in the bipolar plate. The fixation of the gas diffusion layer or electrode minimises the so-called layer tolerance and permits to—at least in part—dispense with complex tools, such as positioning tools or adjusting tools. Neither a frame used for handling nor a gasket for thickness increase is any longer needed. Furthermore, the production process can be designed to be much simpler as several components, e.g. the membrane or MEA, respectively and the GDE or GDL, respectively, can be supplied in the form of rolled goods.

This and also further, not explicitly mentioned objects are achieved by means of the method according to claim 1.

Accordingly, an object of the present invention is a method for the production of an electrochemical cell, in particular an individual cell for fuel cells and/or a fuel cell stack, including
(i) at least one proton-conducting polymer electrolyte membrane (1) or electrolyte matrix (1),
(ii) at least one catalyst layer which in each case is arranged on both sides of the proton-conducting polymer electrolyte membrane or electrolyte matrix,
(iii) at least one electrically conductive gas diffusion layer (2) which in each case is arranged on that side of the catalyst layer facing away from the electrolyte,
(iv) at least one bipolar plate with integrated channels (3) of the flow field which in each case is arranged on those sides of the gas diffusion layer facing away from the catalyst layer,
(v) at least one circumferential constructional element (4) in the boundary area of the gas diffusion layer towards the bipolar plate,
   comprising the following steps:
a) supplying a bipolar plate provided with channels of the flow field,
b) supplying a gas diffusion layer or a gas diffusion layer which has at least one catalyst layer on that side facing away from the bipolar plate and depositing the gas diffusion layer on that part of the bipolar plate provided with the channels of the flow field such that the channels for the process media are completely covered by the gas diffusion layer,
c) producing or attaching a circumferential constructional element on the edge or boundary area of the bipolar plate,
d) supplying and depositing a proton-conducting polymer electrolyte membrane or electrolyte matrix on the surface of the gas diffusion layer or on the catalyst layer applied to the gas diffusion layer,
e) compressing the component obtained in accordance with step d) with another component which has a bipolar plate, a gas diffusion layer, optionally a catalyst layer and a circumferential constructional element in the boundary area of the bipolar plate and was likewise produced in accordance with steps a), b) and c),
   characterized in that the circumferential constructional element (4) produced or attached in accordance with step c) in the constructional inner boundary area projects from the latter and overlaps the outer boundary area of the gas diffusion layer (2) or the gas diffusion layer (2) provided with a catalyst layer and fixes the latter in the recess (5) which has the form of an undercut and is formed by the circumferentially attached constructional element (4) projecting from the inner boundary area and preferably extending towards the direction of the GDL/GDE, and by the bipolar plate (3).

Electrochemical cells, in particular individual cells for fuel cells produced by means of the method according to the invention are easier to produce. By fixing the gas diffusion layer or the gas diffusion layer provided with a catalyst layer to the bipolar plate, smaller tolerances are possible in the production process. The complex positioning of the individual components—one after another and on top of each other—when producing a multi-layer membrane electrode assembly and the deviations/dislocations resulting therefrom are avoided such that homogenous product distributions or tolerances are achieved. In particular, the required components can be supplied and processed in the form of rolled goods. To this end, the individual components in the form of rolled goods for the respective bipolar plate design are trimmed, i.e. cut and subsequently supplied in accordance with step d). By using universal rolled goods, the production process is simplified, materials usage is minimised and the production process can be made more cost-efficient thanks to the reduced complexity of the membrane electrode assembly.

By means of the method according to the invention, prefabricated semi-finished parts comprised of bipolar plate and gas diffusion layer are compressed in which the respective components are aligned with each other and fixed. The membrane or the membrane electrode assembly can then be supplied as a part pre-cut from rolled goods or already completely pre-trimmed.

The method according to the invention likewise allows for producing and optionally storing semi-finished parts or prefabricated components. Thus, variations in demand can be compensated better and a more flexible production with shorter lead times can be made possible.

The circumferential constructional element used according to the invention on the edge or the boundary area of the bipolar plate is a frame-like component which overlaps the gas diffusion layer (2) or the gas diffusion layer (2) provided with a catalyst layer at least in part and fixes the gas diffusion layer in the recess (5) formed by the bipolar plate (3) and the circumferential, frame-shaped component (4) horizontally and vertically, the recess having the form of an undercut. The fixation provides for the gas diffusion layer being in a defined position on the bipolar plate and no longer being displaced in the subsequent production steps. A possible subsequent production step comprises supplying and depositing the membrane or the membrane electrode assembly. This can be in the form of a simple part pre-cut from rolled goods.

The frame-shaped component used according to the invention is preferably formed from a sealing material, in particular based on polymers, or else from a material compatible with the material of the bipolar plate, in particular from the same material as the bipolar plate. In principle, it is also possible to form the frame-shaped component from a separate metal sheet, which advantageously allows to chose the thickness of the sheet. On the other hand, it is also feasible to form the frame by folding over the metal sheet of a metallic bipolar plate which provides for saving material. Compatible materials within the context of the present invention are all materials which—processed to form a frame-shaped component—ensure the horizontal and/or vertical fixation of the gas diffusion layer in the recess. Additionally, such compatible materials have to be suitable for the use in electrochemical cells.

When a sealing material is used as the circumferential constructional element (4) or when this is formed on the edge/boundary area of the bipolar plate, the method according to the invention comprises the steps of
a) supplying a bipolar plate provided with the channels of the flow field, the supplied bipolar plate preferably having a circumferential edge raised compared to the flat area of the bipolar plate having the channels of the flow field, and the surface of the circumferential raised edge and the surface of the flat area of the bipolar plate with the channels of the flow field being arranged essentially parallel to each other,
b) supplying a gas diffusion layer or a gas diffusion layer which has at least one catalyst layer on that side facing away from the bipolar plate and depositing the gas diffusion layer on that part of the bipolar plate provided with the channels of the flow field such that the channels for the process media are completely covered by the gas diffusion layer,
c) producing or attaching a circumferential gasket on the edge or the boundary area of the bipolar plate,
d) supplying and depositing a proton-conducting polymer electrolyte membrane or electrolyte matrix on the surface of the gas diffusion layer or on the catalyst layer applied to the gas diffusion layer,
e) compressing the component obtained in accordance with step d) with another component which has a bipolar plate, a gas diffusion layer, a catalyst layer and a circumferential gasket and was likewise produced in accordance with steps a), b) and c),
   characterized in that the circumferential gasket (4) produced or attached in accordance with step c) in the constructional inner boundary area projects from the latter and overlaps the outer boundary area of the gas diffusion layer (2) or the gas diffusion layer (2) provided with a catalyst layer and fixes the latter in the recess (5) which has the form of an undercut and is formed by the circumferentially attached gasket (4) projecting from the inner boundary area and by the bipolar plate (3).

Depending on the chosen sealing material, it can be advantageous when the bipolar plate (3) used has a circumferential edge (3a) raised relative to the flat area of the bipolar plate having the channels of the flow field. By this measure, on one hand, sealing material can be saved and, on the other hand, it is also possible to use a relatively thin sealing material, for example a printed gasket. When using sealing material with a high permanent set, a raised edge can also be advantageous, to control the compressibility during the production process, for example.

When a frame-shaped component is used as the circumferential constructional element (4), the method according to the invention comprises the steps of
a) supplying a bipolar plate provided with channels of the flow field, the supplied bipolar plate optionally having a circumferential raised edge opposite the flat area of the bipolar plate having the channels of the flow field, and the surface of the circumferential raised edge and the surface of the flat area of the bipolar place with the channels of the flow field being arranged essentially parallel to each other,
b) supplying a gas diffusion layer or a gas diffusion layer which has at least one catalyst layer on that side facing away from the bipolar plate and depositing the gas diffusion layer on that part of the bipolar plate provided with the channels of the flow field such that the channels for the process media are completely covered by the gas diffusion layer,
c) attaching a circumferential, frame-shaped component (3a) on the edge or the boundary area of the bipolar plate,
d) producing or attaching a circumferential gasket (4) on the edge or the boundary area of the circumferential, frame-shaped component (3a) from step c),
e) supplying and depositing a proton-conducting polymer electrolyte membrane (1) or electrolyte matrix (1) on the surface of the gas diffusion layer (2) or on the catalyst layer applied to the gas diffusion layer (2),
f) compressing the component obtained in accordance with step e) with another component which has a bipolar plate, a gas diffusion layer, a catalyst layer and a circumferential, frame-shaped component and was likewise produced in accordance with steps a), b), c) and d),
   characterized in that the circumferential, frame-shaped component (3a) attached in accordance with step c) in the constructional inner boundary area projects from the latter and overlaps the outer boundary area of the gas diffusion layer (2) or the gas diffusion layer (2) provided with a catalyst layer and fixes the latter in the recess (5) which has the form of an undercut and is formed by the circumferentially, frame-shaped component (3a) projecting from the inner boundary area and by the bipolar plate (3).

In a preferred embodiment of the invention, the gasket (4) produced or attached in accordance with step c) or d) features a cavity (4a) in the inner boundary area to receive the proton-conducting polymer electrolyte membrane (1) or electrolyte matrix (1).

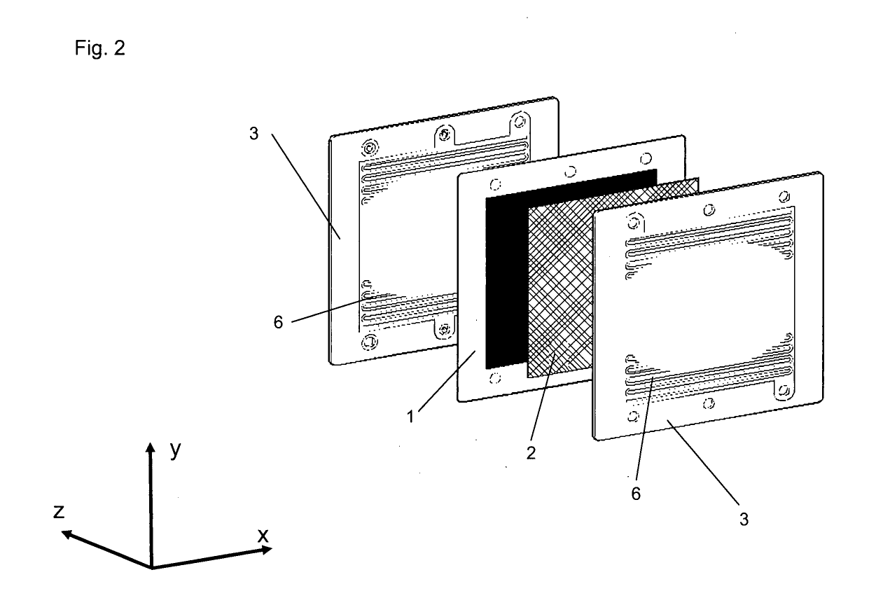

Depending on the nature of the proton-conducting polymer electrolyte membrane or electrolyte matrix used, a so-called “hard stop” function can be included by means of the thickness of the circumferential constructional element or the gasket and the relatively low compressibility thereof. Through this, the degree of compressibility of the proton-conducting polymer electrolyte membrane or electrolyte matrix and the gas diffusion layer is set during the compression such that damage to the proton-conducting polymer electrolyte membrane or electrolyte matrix by a compression force that is too high is avoided (cf. FIG. 2).

When a gas diffusion layer without a catalyst layer is used in the method according to the invention, it is advantageous to use a proton-conducting polymer electrolyte membrane or electrolyte matrix which already has at least one catalyst layer. These are so-called “catalyst-coated membranes”, for example based on Nafion®.

When the bipolar plate has a raised edge, it is advantageous if the surface of the circumferential raised edge and the surface of the lowered area of the bipolar plate with the channels of the flow field are arranged essentially parallel to each other.

The electrochemical cells produced by means of the method according to the invention, in particular individual cells for fuel cells in which the bipolar plate has a frame or constructional elements which project constructionally inwards in the inner boundary area and overlap with the outer boundary area of the gas diffusion layer and fix these, are not known from the prior art. They are likewise an object of the present invention.

Accordingly, an object of the present invention is an electrochemical cell, in particular an individual cell for fuel cells, including
(i) at least one proton-conducting polymer electrolyte membrane (1) or electrolyte matrix (1),
(ii) at least one catalyst layer which in each case is arranged on both sides of the proton-conducting polymer electrolyte membrane or electrolyte matrix,
(iii) at least one electrically conductive gas diffusion layer (2) which in each case is arranged on that side of the catalyst layer facing away from the electrolyte,
(iv) at least one bipolar plate with integrated channels (3) of the flow field which in each case are arranged on that side of the gas diffusion layer facing away from the catalyst layer,
(v) at least one circumferential constructional element (4) in the boundary area of the gas diffusion layer towards the bipolar plate,
   characterized in that the constructional element (4; 3a) projects (5) into the constructional inner boundary area from the latter and covers the outer boundary area of the gas diffusion layer (2) or the gas diffusion layer provided with a catalyst layer and fixes it in the recess (5) which has the form of an undercut and is formed by the circumferential constructional element (4; 3a) and the bipolar plate.

Another object of the present invention are novel semi-finished parts and components which are used in the method according to the invention.

These semi-finished parts are likewise an object of the present invention and comprise:
I) at least one bipolar plate with integrated channels (3) of the flow field, and
II) at least one electrically conductive gas diffusion layer (2) which covers the channels of the flow field of the bipolar plate (3) completely,
III) the bipolar plate (3) in each case being arranged on that side of the gas diffusion layer (2) facing away from the catalyst layer,
   characterized in that the bipolar plate (3) has a constructional element (4; 3a) circumferential in the boundary area which projects (5) into the constructional inner boundary area from the latter and overlaps the outer boundary area of the gas diffusion layer (2) or the gas diffusion layer provided with a catalyst layer and fixes it in the recess (5) which has the form of an undercut and is formed by the circumferential constructional element (4; 3a) and the bipolar plate.

In another embodiment of the semi-finished parts according to the invention, the circumferential constructional element (4) or the gasket (4) features a cavity (4a) in the inner area to receive the proton-conducting polymer electrolyte membrane (1) or electrolyte matrix (1). Depending on the nature of the polymer electrolyte membrane (1) or electrolyte matrix (1), the compressibility of the polymer electrolyte membrane (1) or electrolyte matrix (1) can be influenced by the dimension of the cavity to a certain extent. When relatively soft polymer electrolyte membranes (1) or electrolyte matrices (1) are used, it is advantageous to design the cavity (4a) in such a way that the polymer electrolyte membrane (1) or electrolyte matrix (1) can experience a compression of at least 3%. In this case, the polymer electrolyte membrane (1) or electrolyte matrix (1) projects to such an extent from the cavity to which extent it is to be compressed. Particularly preferably, the cavity described above is chosen such that the compression is at least 5%. Therefore, a compression of more than 80%, in particular more than 30% is chosen as the upper limit, with the gas tightness of the polymer electrolyte membrane (1) or electrolyte matrix (1) having to be kept guaranteed. This embodiment is particularly suited for polymer electrolyte membranes in which the proton-conducting polymer electrolyte membrane comprises acids which are bound to polymers by ionic interaction.

The detailed description of the objects according to the invention is set out below and the respectively preferred embodiments can be freely combined with each other to avoid unnecessary repetitions.

### Proton-Conducting Polymer Electrolyte Membranes and Matrices

Polymer electrolyte membranes and electrolyte matrices, respectively, suited for the purposes of the present invention are known per se.

In addition to the known polymer electrolyte membranes, electrolyte matrices are also suitable. Within the context of the present invention, the term “electrolyte matrices” is understood to mean—besides polymer electrolyte matrices—also other matrix materials in which an ion-conducting material or mixture is fixed or immobilised in a matrix. As an example, mention shall be made here of a matrix made of SiC and phosphoric acid.

In general, polymer electrolyte membranes comprising acids are used wherein the acids may be covalently bound to the polymers. Furthermore, a flat material may be doped with an acid in order to form a suitable membrane.

These doped membranes can, amongst other methods, be produced by swelling flat materials, for example a polymer film, with a fluid comprising acidic compounds, or by manufacturing a mixture of polymers and acidic compounds and subsequently forming a membrane by forming a flat structure and subsequent solidification in order to form a membrane.

Polymers suitable for this purpose include, amongst others, polyolefins, such as poly(chloroprene), polyacetylene, polyphenylene, poly(p-xylylene), polyarylmethylene, polystyrene, polymethylstyrene, polyvinyl alcohol, polyvinyl acetate, polyvinyl ether, polyvinyl amine, poly(N-vinyl acetamide), polyvinyl imidazole, polyvinyl carbazole, polyvinyl pyrrolidone, polyvinyl pyridine, polyvinyl chloride, polyvinylidene chloride, polytetrafluoroethylene, polyhexafluoropropylene, copolymers of PTFE with hexafluoropropylene, with perfluoropropylvinyl ether, with trifluoronitrosomethane, with carbalkoxyperfluoroalkoxyvinyl ether, polychlorotrifluoroethylene, polyvinyl fluoride, polyvinylidene fluoride, polyacrolein, polyacrylamide, polyacrylonitrile, polycyanoacrylates, polymethacrylimide, cycloolefinic copolymers, in particular of norbornenes;

polymers having C—O bonds in the backbone, for example polyacetal, polyoxymethylene, polyether, polypropylene oxide, polyepichlorohydrin, polytetrahydrofuran, polyphenylene oxide, polyether ketone, polyester, in particular polyhydroxyacetic acid, polyethyleneterephthalate, polybutyleneterephthalate, polyhydroxybenzoate, polyhydroxypropionic acid, polypivalolacton, polycaprolacton, polymalonic acid, polycarbonate; polymeric C—S-bonds in the backbone, for example polysulphide ether, polyphenylenesulphide, polysulphones, polyethersulphone;
polymeric C—N bonds in the backbone, for example polyimines, polyisocyanides, polyetherimine, polyetherimides, polyaniline, polyaramides, polyamides, polyhydrazides, polyurethanes, polyimides, polyazoles, polyazole ether ketone, polyazines;
liquid crystalline polymers, in particular Vectra, as well as inorganic polymers, for example polysilanes, polycarbosilanes, polysiloxanes, polysilicic acid, polysilicates, silicones, polyphosphazenes and polythiazyl.

In this connection, alkaline polymers are preferred wherein this particularly applies to membranes doped with acids. Almost all known polymer membranes in which protons can be transported come into consideration as alkaline polymer membranes doped with acid. Here, acids are preferred which are able to transport protons without additional water, for example by means of the so-called “Grotthus mechanism”.

As alkaline polymer within the context of the present invention, preferably an alkaline polymer with at least one nitrogen atom in a repeating unit is used.

According to a preferred embodiment, the repeating unit in the alkaline polymer contains an aromatic ring with at least one nitrogen atom. The aromatic ring is preferably a five-membered or six-membered ring with one to three nitrogen atoms which may be fused to another ring, in particular another aromatic ring.

According to one particular aspect of the present invention, polymers stable at high temperatures are used which contain at least one nitrogen, oxygen and/or sulphur atom in one or in different repeating units.

Within the context of the present invention, stable at high temperatures means a polymer which, as a polymeric electrolyte, can be operated over the long term in a fuel cell at temperatures above 120° C. Over the long term means that a membrane according to the invention can be operated for at least 100 hours, preferably at least 500 hours, at a temperature of at least 80° C., preferably at least 120° C., particularly preferably at least 160° C., without the performance being decreased by more than 50%, based on the initial performance which can be measured according to the method described in WO 01/18894 A2.

The above mentioned polymers can be used individually or as a mixture (blend). Here, preference is given in particular to blends which contain polyazoles and/or polysulphones. In this context, the preferred blend components are polyethersulphone, polyether ketone and polymers modified with sulphonic acid groups, as described in WO 02/36249. By using blends, the mechanical properties can be improved and the material costs can be reduced.

Polyazoles constitute a particularly preferred group of alkaline polymers. An alkaline polymer based on polyazole contains recurring azole units of the general formula (I) and/or (II) and/or (III) and/or (IV) and/or (V) and/or (VI) and/or (VII) and/or (VIII) and/or (IX) and/or (X) and/or (XI) and/or (XII) and/or (XIII) and/or (XIV) and/or (XV) and/or (XVI) and/or (XVII) and/or (XVIII) and/or (XIX) and/or (XX) and/or (XXI) and/or (XXII)

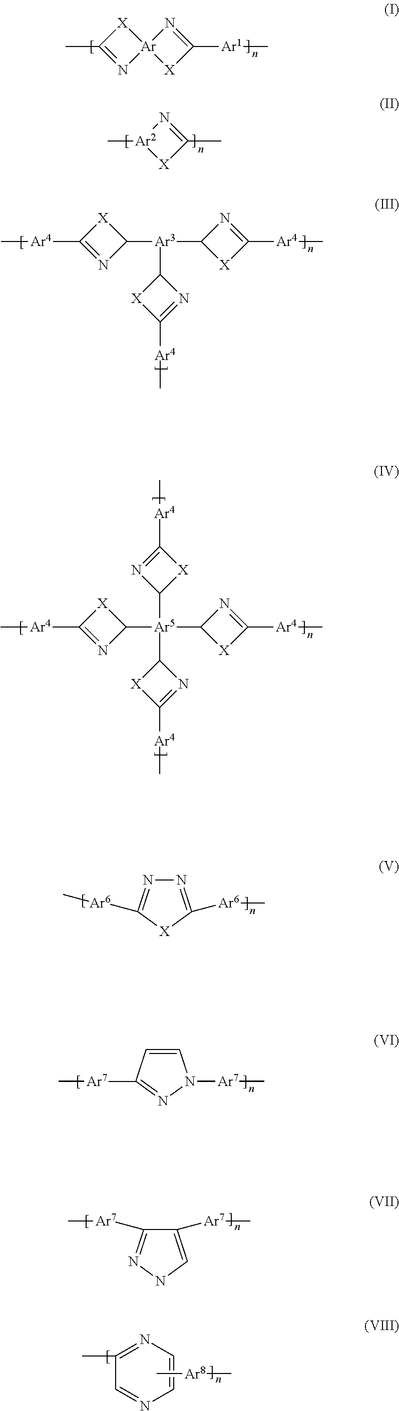

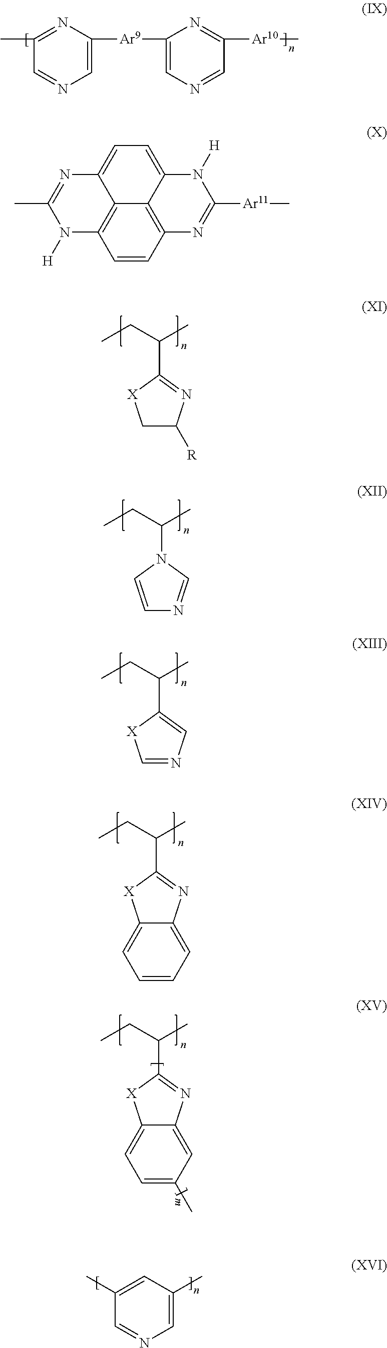

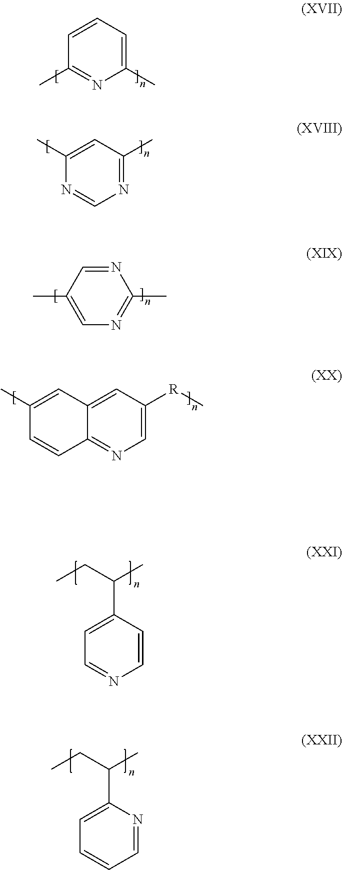

wherein
Ar are identical or different and represent a tetracovalent aromatic or heteroaromatic group which can be monocyclic or polycyclic,
Ar¹ are identical or different and represent a bicovalent aromatic or heteroaromatic group which can be monocyclic or polycyclic,
Ar² are identical or different and represent a bicovalent or tricovalent aromatic or heteroaromatic group which can be monocyclic or polycyclic,
Ar³ are identical or different and represent a tricovalent aromatic or heteroaromatic group which can be monocyclic or polycyclic,
Ar⁴ are identical or different and represent a tricovalent aromatic or heteroaromatic group which can be monocyclic or polycyclic,
Ar⁵ are identical or different and represent a tetracovalent aromatic or heteroaromatic group which can be monocyclic or polycyclic,
Ar⁶ are identical or different and represent a bicovalent aromatic or heteroaromatic group which can be monocyclic or polycyclic,
Ar⁷ are identical or different and represent a bicovalent aromatic or heteroaromatic group which can be monocyclic or polycyclic,
Ar⁸ are identical or different and represent a tricovalent aromatic or heteroaromatic group which can be monocyclic or polycyclic,
Ar⁹ are identical or different and represent a bicovalent or tricovalent or tetracovalent aromatic or heteroaromatic group which can be monocyclic or polycyclic,
Ar¹⁰ are identical or different and represent a bicovalent or tricovalent aromatic or heteroaromatic group which can be monocyclic or polycyclic,
Ar¹¹ are identical or different and represent a bicovalent aromatic or heteroaromatic group which can be monocyclic or polycyclic,
X are identical or different and represent oxygen, sulphur or an amino group which carries a hydrogen atom, a group having 1-20 carbon atoms, preferably a branched or unbranched alkyl or alkoxy group, or an aryl group as a further functional group,
R are identical or different and represent hydrogen, an alkyl group and an aromatic group, with the proviso that R in formula (XX) is not hydrogen, and
   n, m are each an integer greater than or equal to 10, preferably greater than or equal to 100.

Preferred aromatic or heteroaromatic groups are derived from benzene, naphthalene, biphenyl, diphenyl ether, diphenylmethane, diphenyldimethylmethane, bisphenone, diphenylsulphone, quinoline, pyridine, bipyridine, pyridazine, pyrimidine, pyrazine, triazine, tetrazine, pyrrole, pyrazole, anthracene, benzopyrrole, benzotriazole, benzooxathiadiazole, benzooxadiazole, benzopyridine, benzopyrazine,

benzopyrazidine, benzopyrimidine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene which optionally also can be substituted.

In this case, Ar¹, Ar⁴, Ar⁶, Ar⁷, Ar⁸, Ar⁹, Ar¹⁰, Ar¹¹ can have any substitution pattern, in the case of phenylene, for example, Ar¹, Ar⁴, Ar⁶, Ar⁷, Ar⁸, Ar⁹, Ar¹⁰, Ar¹¹ can be ortho-phenylene, meta-phenylene and para-phenylene. Particularly preferred groups are derived from benzene and biphenylene which may also be substituted.

Preferred alkyl groups are short-chain alkyl groups having from 1 to 4 carbon atoms, such as, e.g., methyl, ethyl, n-propyl or i-propyl and t-butyl groups.

Preferred aromatic groups are phenyl or naphthyl groups. The alkyl groups and the aromatic groups can be substituted.

Preferred substituents are halogen atoms, such as, e.g., fluorine, amino groups, hydroxy groups or short-chain alkyl groups, such as, e.g., methyl or ethyl groups.

Preference is given to polyazoles having recurring units of the formula (I) in which the functional groups X within a recurring unit are identical.

The polyazoles can in principle also have different recurring units wherein their functional groups X are different, for example. However, there are preferably only identical functional groups X in a recurring unit.

Further preferred polyazole polymers are polyimidazoles, polybenzothiazoles, polybenzoxazoles, polyoxadiazoles, polyquinoxalines, polythiadiazoles, poly(pyridines), poly(pyrimidines) and poly(tetrazapyrenes).

In another embodiment of the present invention, the polymer containing recurring azole units is a copolymer or a blend which contains at least two units of the formulae (I) to (XXII) which differ from one another. The polymers can be in the form of block copolymers (diblock, triblock), random copolymers, periodic copolymers and/or alternating polymers.

In a particularly preferred embodiment of the present invention, the polymer containing recurring azole units is a polyazole which only contains units of the formulae (I) and/or (II).

The number of recurring azole units in the polymer is preferably an integer greater than or equal to 10. Particularly preferred polymers contain at least 100 recurring azole units.

Within the scope of the present invention, polymers containing recurring benzimidazole units are preferred. Some examples of the most useful polymers containing recurring benzimidazole units are represented by the following formulae:

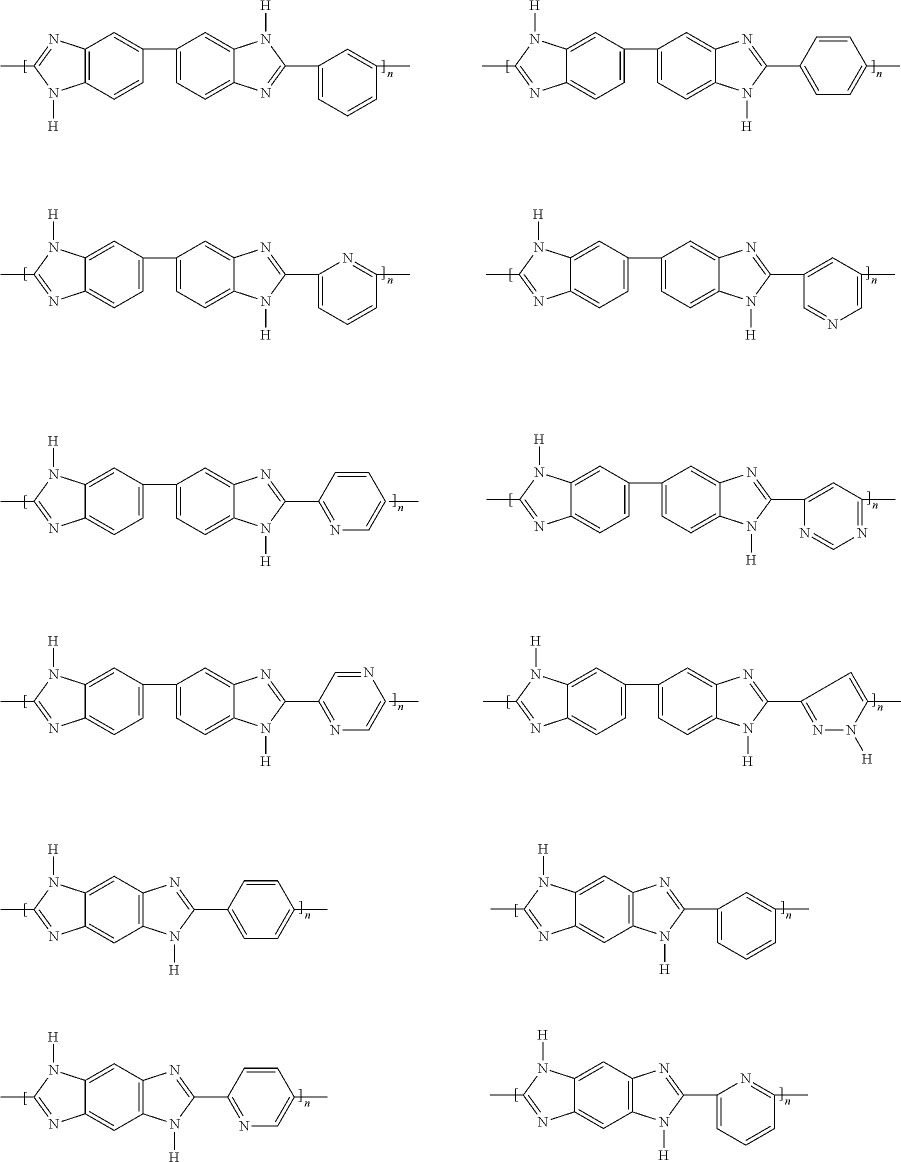

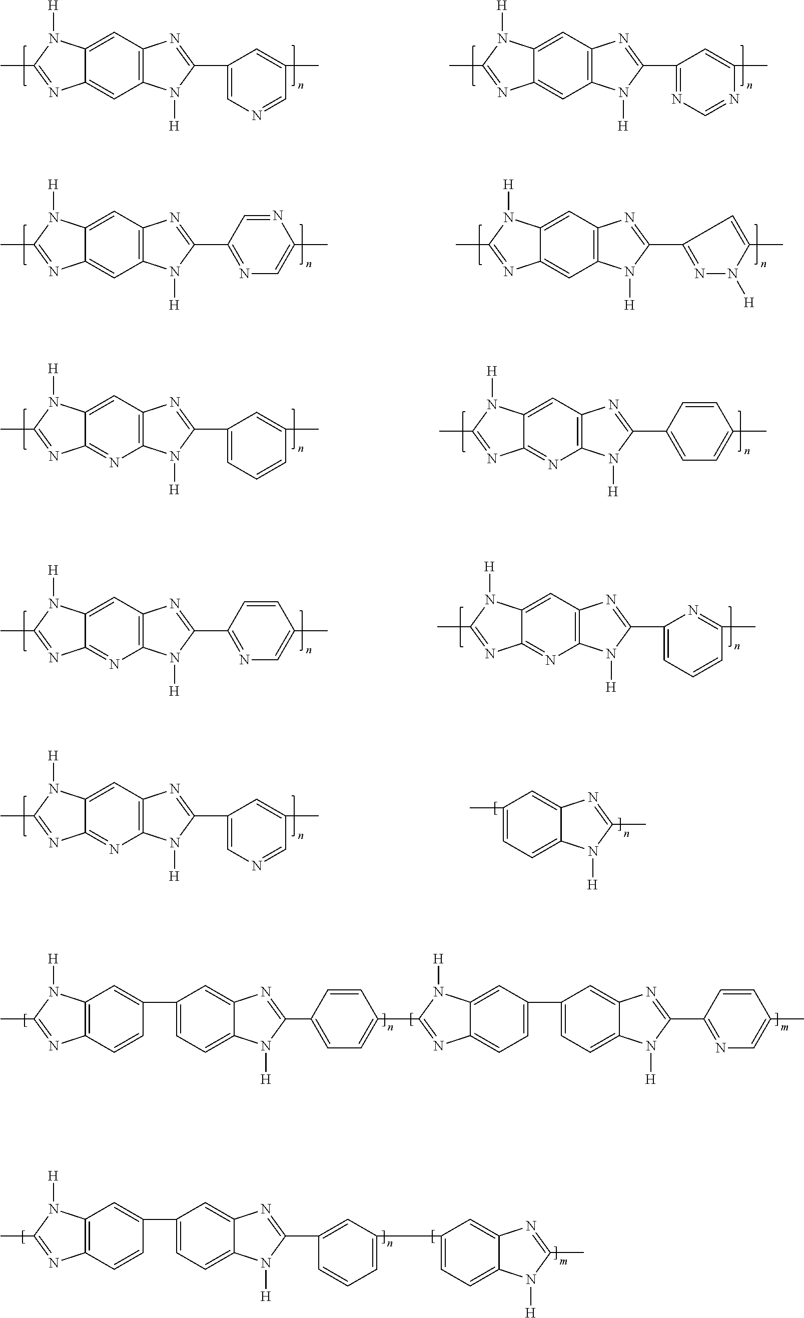

wherein n and m are each an integer greater than or equal to 10, preferably greater than or equal to 100.

The polyazoles used, in particular, however, the polybenzimidazoles are characterized by a high molecular weight. Measured as the intrinsic viscosity, this is preferably at least 0.2 dl/g, preferably 0.8 to 10 dl/g, in particular 1 to 10 dl/g.

The preparation of such polyazoles is known wherein one or more aromatic tetra-amino compounds are reacted in the melt with one or more aromatic carboxylic acids or the esters thereof, containing at least two acid groups per carboxylic acid monomer, to form a prepolymer. The resulting prepolymer solidifies in the reactor and is then comminuted mechanically. The pulverulent prepolymer is usually fully polymerised in a solid-state polymerisation at temperatures of up to 400° C.

The preferred aromatic carboxylic acids are, amongst others, dicarboxylic and tricarboxylic acids and tetracarboxylic acids or their esters or their anhydrides or their acid chlorides. The term aromatic carboxylic acids likewise also comprises heteroaromatic carboxylic acids.

Preferably, the aromatic dicarboxylic acids are isophthalic acid, terephthalic acid, phthalic acid, 5-hydroxyisophthalic acid, 4-hydroxyisophthalic acid, 2-hydroxyterephthalic acid, 5-aminoisophthalic acid, 5-N,N-dimethylaminoisophthalic acid, 5-N,N-diethylaminoisophthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 3-fluorophthalic acid, 5-fluoroisophthalic acid, 2-fluoroterephthalic acid, tetrafluorophthalic acid, tetrafluoroisophthalic acid, tetrafluoroterephthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, 2,2-bis-(4-carboxyphenyl)hexafluoropropane, 4,4′-stilbenedicarboxylic acid, 4-carboxycinnamic acid or their C1-C20 alkyl esters or C5-C12 aryl esters or their acid anhydrides or their acid chlorides.

The aromatic tricarboxylic acids, tetracarboxylic acids or their C1-C20 alkyl esters or C5-C12 aryl esters or their acid anhydrides or their acid chlorides are preferably 1,3,5-benzenetricarboxylic acid (trimesic acid), 1,2,4-benzenetricarboxylic acid (trimellitic acid), (2-carboxyphenyl)iminodiacetic acid, 3,5,3′-biphenyltricarboxylic acid or 3,5,4′-biphenyltricarboxylic acid.

The aromatic tetracarboxylic acids or their C1-C20 alkyl esters or C5-C12 aryl esters or their acid anhydrides or their acid chlorides are preferably 3,5,3′,5′-biphenyltetracarboxylic acid, 1,2,4,5-benzenetetracarboxylic acid, benzophenonetetracarboxylic acid, 3,3′,4,4′-biphenyltetracarboxylic acid, 2,2′,3,3′-biphenyltetracarboxylic acid, 1,2,5,6-naphthalenetetracarboxylic acid or 1,4,5,8-naphthalenetetracarboxylic acid.

The heteroaromatic carboxylic acids used are preferably heteroaromatic dicarboxylic acids, tricarboxylic acids and tetracarboxylic acids or their esters or their anhydrides. Heteroaromatic carboxylic acids are understood to mean aromatic systems which contain at least one nitrogen, oxygen, sulphur or phosphorus atom in the aromatic group. These are preferably pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid, 2,4,6-pyridinetricarboxylic acid or benzimidazole-5,6-dicarboxylic acid and their C1-C20 alkyl esters or C5-C12 aryl esters or their acid anhydrides or their acid chlorides.

The content of tricarboxylic acids or tetracarboxylic acids (based on dicarboxylic acid used) is between 0 and 30 mol-%, preferably 0.1 and 20 mol-%, in particular 0.5 and 10 mol-%.

The aromatic and heteroaromatic diaminocarboxylic acids used are preferably diaminobenzoic acid or its monohydrochloride and dihydrochloride derivatives.

Preferably, mixtures of at least 2 different aromatic carboxylic acids are used. Particularly preferably, mixtures are used which also contain heteroaromatic carboxylic acids in addition to aromatic carboxylic acids. The mixing ratio of aromatic carboxylic acids to heteroaromatic carboxylic acids is between 1:99 and 99:1, preferably 1:50 to 50:1.

These mixtures are in particular mixtures of N-heteroaromatic dicarboxylic acids and aromatic dicarboxylic acids. Non-limiting examples of these are isophthalic acid, terephthalic acid, phthalic acid, 2,5-dihydroxyterephthalic acid, 2,6-dihydroxyisophthalic acid, 4,6-dihydroxyisophthalic acid, 2,3-dihydroxyphthalic acid, 2,4-dihydroxyphthalic acid, 3,4-dihydroxyphthalic acid, 1,4-naphthalenedicarboxylic acid, 1,5-naphthalenedicarboxylic acid, 2,6-naphthalenedicarboxylic acid, 2,7-naphthalenedicarboxylic acid, diphenic acid, 1,8-dihydroxynaphthalene-3,6-dicarboxylic acid, diphenyl ether-4,4′-dicarboxylic acid, benzophenone-4,4′-dicarboxylic acid, diphenylsulphone-4,4′-dicarboxylic acid, biphenyl-4,4′-dicarboxylic acid, 4-trifluoromethylphthalic acid, pyridine-2,5-dicarboxylic acid, pyridine-3,5-dicarboxylic acid, pyridine-2,6-dicarboxylic acid, pyridine-2,4-dicarboxylic acid, 4-phenyl-2,5-pyridinedicarboxylic acid, 3,5-pyrazoledicarboxylic acid, 2,6-pyrimidinedicarboxylic acid, 2,5-pyrazinedicarboxylic acid.

The preferred aromatic tetramino compounds include, amongst others, 3,3′,4,4′-tetraminobiphenyl, 2,3,5,6-tetraminopyridine, 1,2,4,5-tetraminobenzene, 3,3′,4,4′-tetraminodiphenyl sulphone, 3,3′,4,4′-tetraminodiphenyl ether, 3,3′,4,4′-tetraminobenzophenone, 3,3′,4,4′-tetraminodiphenylmethane and 3,3′,4,4′-tetraminodiphenyldimethylmethane as well as their salts, in particular their monohydrochloride, dihydrochloride, trihydrochloride and tetrahydrochloride derivatives.

Preferred polybenzimidazoles are commercially available under the trade name ®Celazole.

Preferred polymers include polysulphones, in particular polysulphone having aromatic and/or heteroaromatic groups in the backbone. According to a particular aspect of the present invention, preferred polysulphones and polyethersulphones have a melt volume rate MVR 300/21.6 of less than or equal to 40 cm³/10 min, in particular less than or equal to 30 cm^{3/10} min and particularly preferably less than or equal to 20 cm^{3/10} min, measured in accordance with ISO 1133. Here, preference is given to polysulphones with a Vicat softening temperature VST/A/50 of 180° C. to 230° C. In yet another preferred embodiment of the present invention, the number average of the molecular weight of the polysulphones is greater than 30,000 g/mol.

The polymers based on polysulphone include in particular polymers having recurring units with linking sulphone groups according to the general formulae A, B, C, D, E, F and/or G:

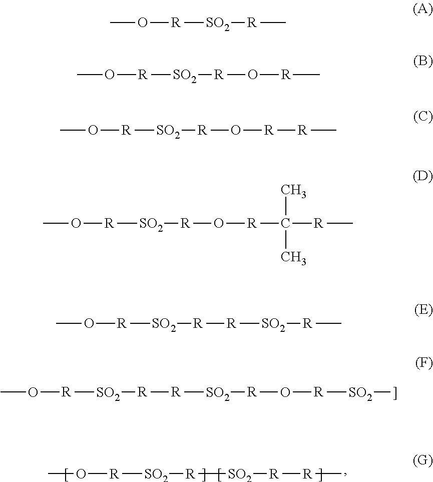

wherein the functional groups R, independently of another, are identical or different and represent aromatic or heteroaromatic groups, these functional groups having been explained in detail above. These include in particular 1,2-phenylene, 1,3-phenylene, 1,4-phenylene, 4,4′-biphenyl, pyridine, quinoline, naphthalene, phenanthrene.

The polysulphones preferred within the scope of the present invention include homopolymers and copolymers, for example random copolymers. Particularly preferred polysulphones comprise recurring units of the formulae H to N:

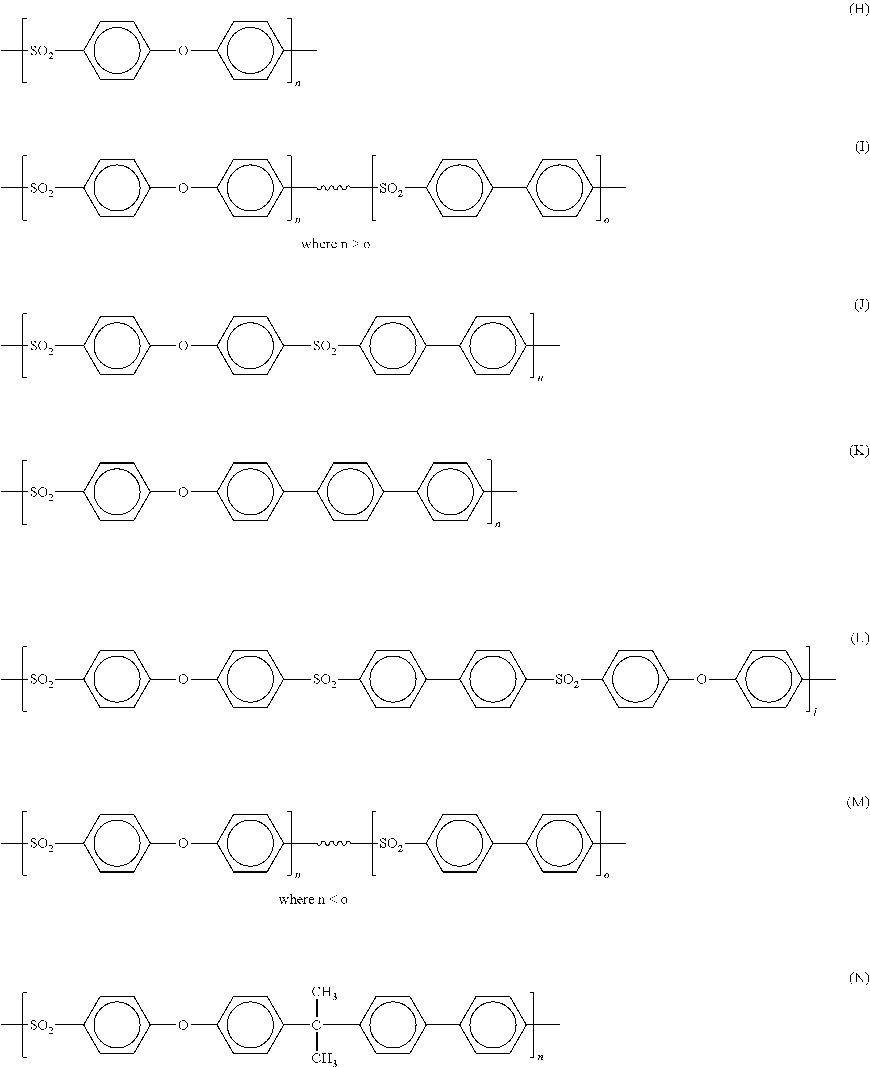

The previously described polysulphones can be obtained commercially under the trade names ®Victrex 200 P, ®Victrex 720 P, ®Ultrason E, ®Ultrason S, ®Mindel, ®Radel A, ®Radel R, ®Victrex HTA, ®Astrel and ®Udel.

Furthermore, polyether ketones, polyether ketone ketones, polyether ether ketones, polyether ether ketone ketones and polyaryl ketones are particularly preferred. These high-performance polymers are known per se and can be obtained commercially under the trade names Victrex® PEEK™, ®Hostatec, ®Kadel.

The polysulphones mentioned above and the polyether ketones, polyether ketone ketones, polyether ether ketones, polyether ether ketone ketones and polyaryl ketones mentioned can be, as already set forth, present as a blend component with alkaline polymers. Furthermore, the polysulphones mentioned above and the polyether ketones, polyether ketone ketones, polyether ether ketones, polyether ether ketone ketones and polyaryl ketones mentioned above can be used in sulphonated form as a polymer electrolyte wherein the sulphonated materials can also feature alkaline polymers, in particular polyazoles as a blend material. The embodiments shown and preferred with regard to the alkaline polymers or polyazoles also apply to these embodiments.

To produce polymer films, a polymer, preferably an alkaline polymer, in particular a polyazole can be dissolved in an additional step in polar, aprotic solvents such as dimethylacetamide (DMAc) and a film can be produced by means of classical methods.

In order to remove residues of solvents, the film thus obtained can be treated with a washing liquid, as is described in WO 02/07518. Due to the cleaning of the polyazole film to remove residues of solvent described patent application mentioned above, the mechanical properties of the film are surprisingly improved. These properties include in particular the E-modulus, the tear strength and the break strength of the film.

Additionally, the polymer film can have further modifications, for example by cross-linking, as described in WO 02/070592 or in WO 00/44816. In a preferred embodiment, the polymer film used consisting of an alkaline polymer and at least one blend component additionally contains a cross-linking agent, as described in WO 03/016384.

The thickness of the polyazole films can be within wide ranges. Preferably, the thickness of the polyazole film before its doping with acid is in the range of 5 μm to 2000 μm, particularly preferably in the range of 10 μm to 1000 μm; however, this should not constitute a limitation.

In order to achieve proton conductivity, these films are doped with an acid. In this context, acids include all known Lewis und Brønsted acids, preferably inorganic Lewis und Brønsted acids.

Furthermore, the use of polyacids is also possible, in particular isopolyacids and heteropolyacids as well as mixtures of different acids. Here, within the context of the invention, heteropolyacids define inorganic polyacids with at least two different central atoms, each formed of weak, polybasic oxygen acids of a metal (preferably Cr, MO, V, W) and a non-metal (preferably As, I, P, Se, Si, Te) as partial mixed anhydrides. These include, amongst others, the 12-phosphomolybdatic acid and the 12-phosphotungstic acid.

The conductivity of the polyazole film can be influenced via the degree of doping. The conductivity increases with an increasing concentration of the doping substance until a maximum value is reached. According to the invention, the degree of doping is given as mole of acid per mole of repeating unit of the polymer. Within the scope of the present invention, a degree of doping between 3 and 50, in particular between 5 and 40 is preferred.

Particularly preferred doping substances are sulphuric acid and phosphoric acid or compounds releasing these acids, for example during hydrolysis. A very particularly preferred doping substance is phosphoric acid (H₃PO₄). Here, highly concentrated acids are generally used. According to a particular aspect of the present invention, the concentration of the phosphoric acid is at least 50% by weight, in particular at least 80% by weight, based on the weight of the doping substance.

Furthermore, proton-conductive membranes can also be obtained by a method comprising the steps of
I) dissolving of polymers, particularly polyazoles in phosphoric acid,
II) heating the mixture obtainable in accordance with step A) under inert gas to temperatures of up to 400° C.,
III) forming a membrane using the solution of the polymer in accordance with step II) on a support and
IV) treating the membrane formed in step III) until it is self-supporting.

Furthermore, doped polyazole films can be obtained by a method comprising the steps of
A) mixing one or more aromatic tetramino compounds with one or more aromatic carboxylic acids or their esters, which contain at least two acid groups per carboxylic acid monomer, or mixing one or more aromatic and/or heteroaromatic diaminocarboxylic acids in polyphosphoric acid with formation of a solution and/or dispersion,
B) applying a layer using the mixture in accordance with step A) to a support or to an electrode,
C) heating the flat structure/layer obtainable in accordance with step B) under inert gas to temperatures of up to 350° C., preferably up to 280° C., with formation of the polyazole polymer,
D) treating the membrane formed in step C) (until it is self-supporting).

The aromatic or heteroaromatic carboxylic acid and tetramino compounds to be used in step A) have been described above.

The polyphosphoric acid used in step A) is a customary polyphosphoric acid as is available, for example, from Riedel-de Haen. The polyphosphoric acids Hₙ₊₂PₙO₃ₙ₊₁ (n>1) usually have a concentration of at least 83%, calculated as P₂O₅ (by acidimetry). Instead of a solution of the monomers, it is also possible to produce a dispersion/suspension.

The mixture produced in step A) has a weight ratio of polyphosphoric acid to the sum of all monomers of 1:10,000 to 10,000:1, preferably 1:1000 to 1000:1, in particular 1:100 to 100:1.

The layer formation in accordance with step B) is performed by means of measures known per se (pouring, spraying, application with a doctor blade) which are known from the prior art of polymer film production. Every support that is considered as inert under the conditions is suitable as a support. To adjust the viscosity, phosphoric acid (conc. phosphoric acid, 85%) can be added to the solution, where required. Thus, the viscosity can be adjusted to the desired value and the formation of the membrane be facilitated.

The layer produced in accordance with step B) has a thickness of 10 to 4000 μm, preferably 20 to 4000 μm, very preferably of 30 to 3500 μm, in particular of 50 to 3000 μm.

If the mixture in accordance with step A) also contains tricarboxylic acids or tetracarboxylic acid, branching/cross-linking of the formed polymer is achieved therewith. This contributes to an improvement in the mechanical property. The treatment of the polymer layer produced in accordance with step C) is performed in the presence of moisture at temperatures and for a sufficient period of time until the layer exhibits a sufficient strength for use in fuel cells. The treatment can be effected to the extent that the membrane is self-supporting so that it can be detached from the support without any damage.

In accordance with step C), the flat structure obtained in step B) is heated to a temperature of up to 350° C., preferably up to 280° C. and particularly preferably in the range of 200° C. to 250° C. The inert gases to be used in step C) are known to those in professional circles. These include in particular nitrogen as well as noble gases, such as neon, argon, helium.

In a variant of the method, the formation of oligomers and/or polymers can already be brought about by heating the mixture from step A) to temperatures of up to 350° C., preferably up to 280° C. Depending on the selected temperature and duration, it is then possible to dispense partly or fully with the heating in step C). This variant is also an object of the present invention.

The treatment of the membrane in step D) is performed at temperatures of more than 0° C. and less than 150° C., preferably at temperatures between 10° C. and 120° C., in particular between room temperature (20° C.) and 90° C., in the presence of moisture or water and/or steam and/or water-containing phosphoric acid of up to 85%. The treatment is preferably performed at normal pressure, but can also be carried out with action of pressure. It is essential that the treatment takes place in the presence of sufficient moisture whereby the polyphosphoric acid present contributes to the solidification of the membrane by means of partial hydrolysis with formation of low molecular weight polyphosphoric acid and/or phosphoric acid.

The hydrolysis fluid may be a solution wherein the fluid may also contain suspended and/or dispersed constituents. The viscosity of the hydrolysis fluid can be within wide ranges wherein an addition of solvents or an increase in temperature can take place to adjust the viscosity. The dynamic viscosity is preferably in the range of 0.1 to 10,000 mPa*s, in particular 0.2 to 2000 mPa*s, wherein these values can be measured in accordance with DIN 53015, for example.

The treatment in accordance with step D) can take place with any known method. The membrane obtained in step C) can, for example, be immersed in a fluid bath. Furthermore, the hydrolysis fluid can be sprayed onto the membrane. Additionally, the hydrolysis fluid can be poured onto the membrane. The latter methods have the advantage that the concentration of the acid in the hydrolysis fluid remains constant during the hydrolysis. However, the first method is often cheaper in practice.

The oxo acids of phosphorus and/or sulphur include in particular phosphinic acid, phosphonic acid, phosphoric acid, hypodiphosphonic acid, hypodiphosphoric acid, oligophosphoric acids, sulphurous acid, disulphurous acid and/or sulphuric acid. These acids can be used individually or as a mixture.

Furthermore, the oxo acids of phosphorus and/or sulphur comprise monomers that can be processed by free-radical polymerisation and comprise phosphonic acid and/or sulphonic acid groups.

Monomers comprising phosphonic acid groups are known in professional circles. These are compounds having at least one carbon-carbon double bond and at least one phosphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising phosphonic acid groups results from the polymerisation product which is obtained by polymerising the monomer comprising phosphonic acid groups alone or with other monomers and/or cross-linking agents.

The monomer comprising phosphonic acid groups may comprise one, two, three or more carbon-carbon double bonds. Furthermore, the monomer comprising phosphonic acid groups may contain one, two, three or more phosphonic acid groups.

In general, the monomer comprising phosphonic acid groups contains 2 to 20, preferably 2 to 10 carbon atoms.

The monomer comprising phosphonic acid groups is preferably a compound of the formula

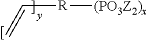

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned functional groups themselves can be substituted with halogen, —OH, —CN, and
x represents an integer 1, 2, 3, 4, 5, 6, 7, 8, 9 or 10
y represents an integer 1, 2, 3, 4, 5, 6, 7, 8, 9 or 10,
   and/or of the formula

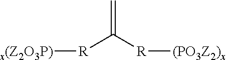

wherein
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10,
   and/or of the formula

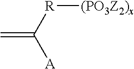

wherein
A represents a group of the formulae COOR², CN, CONR²₂, OR² and/or R²,
   wherein R² is hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10.

Preferred monomers comprising phosphonic acid groups include, inter alia, alkenes which contain phosphonic acid groups, such as ethenephosphonic acid, propenephosphonic acid, butenephosphonic acid; acrylic acid compounds and/or methacrylic acid compounds which contain phosphonic acid groups, such as for example 2-phosphonomethylacrylic acid, 2-phosphonomethylmethacrylic acid, 2-phosphonomethylacrylamide and 2-phosphonomethylmethacrylamide.

Commercially available vinylphosphonic acid (ethenephosphonic acid), such as it is available from the companies Aldrich or Clariant GmbH, for example, is particularly preferably used. A preferred vinylphosphonic acid has a purity of more than 70%, in particular 90% and particularly preferably a purity of more than 97%.

The monomers comprising phosphonic acid groups can furthermore be used in the form of derivatives which can subsequently be converted to the acid, wherein the conversion to the acid may also take place in the polymerised state. These derivatives include in particular the salts, the esters, the amides and the halides of the monomers comprising phosphonic acid groups.

Furthermore, the monomers comprising phosphonic acid groups can also be introduced onto and into the membrane after the hydrolysis. This can be performed by means of measures known per se (e.g., spraying, immersing, etc.) which are known from the prior art.

According to a particular aspect of the present invention, the ratio of the weight of the sum of phosphoric acid, polyphosphoric acid and the hydrolysis products of the polyphosphoric acid to the weight of the monomers that can be processed by free-radical polymerisation, for example the monomers comprising phosphonic acid groups, is preferably greater than or equal to 1:2, in particular greater than or equal to 1:1 and particularly preferably greater than or equal to 2:1.

Preferably, the ratio of the weight of the sum of phosphoric acid, polyphosphoric acid and the hydrolysis products of the polyphosphoric acid to the weight of the monomers that can be processed by free-radical polymerisation is in the range of 1000:1 to 3:1, in particular 100:1 to 5:1 and particularly preferably 50:1 to 10:1.

This ratio can easily be determined by means of customary methods in which, in many cases, the phosphoric acid, polyphosphoric acid and their hydrolysis products can be washed out of the membrane. Through this, the weight of the polyphosphoric acid and its hydrolysis products can be obtained after the completed hydrolysis to phosphoric acid. In general, this also applies to the monomers which can be processed by free-radical polymerisation.

Monomers comprising sulphonic acid groups are known in professional circles. These are compounds having at least one carbon-carbon double bond and at least one sulphonic acid group. Preferably, the two carbon atoms forming the carbon-carbon double bond have at least two, preferably 3, bonds to groups which lead to minor steric hindrance of the double bond. These groups include, amongst others, hydrogen atoms and halogen atoms, in particular fluorine atoms. Within the scope of the present invention, the polymer comprising sulphonic acid groups results from the polymerisation product which is obtained by polymerisation of the monomer comprising sulphonic acid groups alone or with further monomers and/or cross-linking agents.

The monomer comprising sulphonic acid groups may comprise one, two, three or more carbon-carbon double bonds. Furthermore, the monomer comprising sulphonic acid groups can contain one, two, three or more sulphonic acid groups.

In general, the monomer comprising sulphonic acid groups contains 2 to 20, preferably 2 to 10 carbon atoms.

The monomer comprising sulphonic acid groups is preferably a compound of the formula

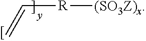

wherein
R represents a bond, a bicovalent C1-C15 alkylene group, a bicovalent C1-C15 alkyleneoxy group, for example ethyleneoxy group, or a bicovalent C5-C20 aryl or heteroaryl group, wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group wherein the above-mentioned functional groups themselves can be substituted with halogen, —OH, —CN, and
x represents an integer 1, 2, 3, 4, 5, 6, 7, 8, 9 or 10,
y represents an integer 1, 2, 3, 4, 5, 6, 7, 8, 9 or 10,
   and/or of the formula

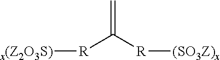

wherein
R represents a bond, a bicovalent C1-C15 alkylene group, a bicovalent C1-C15 alkyleneoxy group, for example ethyleneoxy group, or a bicovalent C5-C20 aryl or heteroaryl group, wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10,
   and/or of the formula

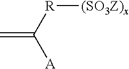

wherein
A represents a group of the formulae COOR², CN, CONR²₂, OR² and/or R²,
   wherein R² is hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, COOZ, —CN, NZ₂,
R represents a bond, a bicovalent C1-C15 alkylene group, a bicovalent C1-C15 alkyleneoxy group, for example ethyleneoxy group, or a bicovalent C5-C20 aryl or heteroaryl group, wherein the above-mentioned functional groups themselves can be substituted with halogen, —OH, COOZ, —CN, NZ₂,
Z represent, independently of another, hydrogen, a C1-C15 alkyl group, a C1-C15 alkoxy group, an ethyleneoxy group or a C5-C20 aryl or heteroaryl group, wherein the above-mentioned functional groups themselves can be substituted with halogen, —OH, —CN, and
x represents an integer 1, 2, 3, 4, 5, 6, 7, 8, 9 or 10.

Preferred monomers comprising sulphonic acid groups include, inter alia, alkenes which contain sulphonic acid groups, such as ethenesulphonic acid, propenesulphonic acid, butenesulphonic acid; acrylic acid compounds and/or methacrylic acid compounds which contain sulphonic acid groups, such as for example 2-sulphonomethylacrylic acid, 2-sulphonomethylmethacrylic acid, 2-sulphonomethylacrylamide and 2-sulphonomethylmethacrylamide.

Commercially available vinylsulphonic acid (ethenesulphonic acid), such as it is available from the companies Aldrich or Clariant GmbH, for example, is particularly preferably used. A preferred vinylsulphonic acid has a purity of more than 70%, in particular 90% and particularly preferably a purity of more than 97%.

The monomers comprising sulphonic acid groups can furthermore be used in the form of derivatives which can subsequently be converted to the acid, wherein the conversion to the acid may also take place in the polymerised state. These derivatives include in particular the salts, the esters, the amides and the halides of the monomers comprising sulphonic acid groups.

Furthermore, the monomers comprising sulphonic acid groups can also be introduced onto and into the membrane after the hydrolysis. This can be performed by means of measures known per se (e.g., spraying, immersing, etc.) which are known from the prior art.

In another embodiment of the invention, monomers capable of cross-linking can be used. These monomers can be added to the hydrolysis fluid. Furthermore, the monomers capable of cross-linking can also be applied to the membrane obtained after the hydrolysis.

The monomers capable of cross-linking are in particular compounds having at least 2 carbon-carbon double bonds. Preference is given to dienes, trienes, tetraenes, dimethylacrylates, trimethylacrylates, tetramethylacrylates, diacrylates, triacrylates, tetraacrylates.

Particular preference is given to dienes, trienes, tetraenes of the formula

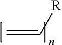

dimethylacrylates, trimethylacrylates, tetramethylacrylates of the formula

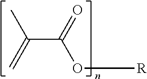

diacrylates, triacrylates, tetraacrylates of the formula

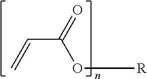

wherein
R represents a C1-C15 alkyl group, a C5-C20 aryl or heteroaryl group, NR′, —SO₂, PR′, Si(R′)₂, wherein the above-mentioned functional groups themselves can be substituted,
R′ represent, independently of another, hydrogen, a C1-C15 alkyl group, a C1-C15 alkoxy group, a C5-C20 aryl or heteroaryl group, and
n is at least 2.

The substituents of the above-mentioned functional group R are preferably halogen, hydroxyl, carboxy, carboxyl, carboxylester, nitriles, amines, silyl, siloxane groups.

Particularly preferred cross-linking agents are allyl methacrylate, ethylene glycol dimethacrylate, diethylene glycol dimethacrylate, triethylene glycol dimethacrylate, tetraethylene glycol dimethacrylate and polyethylene glycol dimethacrylate, 1,3-butanediol dimethacrylate, glycerol dimethacrylate, diurethane dimethacrylate, trimethylpropane trimethacrylate, epoxy acrylates, for example ebacryl, N′,N-methylenebisacrylamide, carbinol, butadiene, isoprene, chloroprene, divinylbenzene and/or bisphenol A dimethylacrylate. These compounds are commercially available from Sartomer Company Exton, Pa. under the designations CN120, CN104 and CN980, for example.

The use of cross-linking agents is optional wherein these compounds can typically be used in the range of 0.05 to 30% by weight, preferably 0.1 to 20% by weight, particularly preferably 1 to 10% by weight, based on the weight of the membrane.

The cross-linking monomers can be introduced onto and into the membrane after the hydrolysis. This can be performed by means of measures known per se (e.g., spraying, immersing etc.) which are known from the prior art.

According to a particular aspect of the present invention, the monomers comprising phosphonic acid and/or sulphonic acid groups or the cross-linking monomers can be polymerised wherein the polymerisation is preferably a free-radical polymerisation. The formation of radicals can take place thermally, photochemically, chemically and/or electrochemically.

For example, a starter solution containing at least one substance capable of forming radicals can be added to the hydrolysis fluid. Furthermore, a starter solution can be applied to the membrane after the hydrolysis. This can be performed by means of measures known per se (e.g., spraying, immersing etc.) which are known from the prior art.

Suitable radical formers are, amongst others, azo compounds, peroxy compounds, persulphate compounds or azoamidines. Non-limiting examples are dibenzoyl peroxide, dicumene peroxide, cumene hydroperoxide, diisopropyl peroxydicarbonate, bis(4-t-butylcyclohexyl) peroxydicarbonate, dipotassium persulphate, ammonium peroxydisulphate, 2,2′-azobis(2-methylpropionitrile) (AIBN), 2,2′-azobis(isobutyric acid amidine)hydrochloride, benzopinacol, dibenzyl derivatives, methyl ethylene ketone peroxide, 1,1-azobiscyclohexanecarbonitrile, methyl ethyl ketone peroxide, acetyl acetone peroxide, dilauryl peroxide, didecanoyl peroxide, tert-butylper-2-ethyl hexanoate, ketone peroxide, methyl isobutyl ketone peroxide, cyclohexanone peroxide, dibenzoyl peroxide, tert-butylperoxybenzoate, tert-butylperoxyisopropylcarbonate, 2,5-bis(2-ethylhexanoylperoxy)-2,5-dimethylhexane, tert-butylperoxy-2-ethylhexanoate, tert-butylperoxy-3,5,5-trimethylhexanoate, tert-butylperoxyisobutyrate, tert-butylperoxyacetate, dicumene peroxide, 1,1-bis(tert-butylperoxy)cyclohexane, 1,1-bis(tert-butylperoxy)-3,3,5-trimethylcyclohexane, cumyl hydroperoxide, tert-butylhydroperoxide, bis(4-tert-butylcyclohexyl)peroxydicarbonate, and the radical formers available from DuPont under the name ®Vazo, for example ®Vazo V50 and ®Vazo WS.

Furthermore, use may also be made of radical formers which form free radicals when exposed to radiation. Preferred compounds include, amongst others, α,α-diethoxyacetophenone (DEAP, Upjon Corp), n-butyl benzoin ether (®Trigonal-14, AKZO) and 2,2-dimethoxy-2-phenylacetophenone (®Igacure 651) and 1-benzoyl cyclohexanol (®Igacure 184), bis-(2,4,6-trimethylbenzoyl)phenylphosphine oxide (®Irgacure 819) and 1-[4-(2-hydroxyethoxy)phenyl]-2-hydroxy-2-phenylpropan-1-one (®Irgacure 2959), each of which are commercially available from the company Ciba Geigy Corp.

Typically, between 0.0001 and 5% by weight, in particular 0.01 to 3% by weight (based on the weight of the monomers that can be processed by free-radical polymerisation; monomers comprising phosphonic acid groups and/or sulphonic acid groups or the cross-linking monomers, respectively) of radical formers are added. The amount of radical formers can be varied according to the degree of polymerisation desired.

The polymerisation can also take place by action of IR or NIR (IR=infrared, i.e. light having a wavelength of more than 700 nm; NIR=near-IR, i.e. light having a wavelength in the range of about 700 to 2000 nm and an energy in the range of about 0.6 to 1.75 eV), respectively.

The polymerisation can also take place by action of UV light having a wavelength of less than 400 nm. This polymerisation method is known per se and described, for example, in Hans Joerg Elias, Makromolekulare Chemie, 5th edition, volume 1, pp. 492-511; D. R. Arnold, N. C. Baird, J. R. Bolton, J. C. D. Brand, P. W. M Jacobs, P. de Mayo, W. R. Ware, Photochemistry—An Introduction, Academic Press, New York and M. K. Mishra, Radical Photopolymerization of Vinyl Monomers, J. Macromol. Sci.—Revs. Macromol. Chem. Phys. C22 (1982-1983) 409.

The polymerisation may also take place by exposure to β rays, γ rays and/or electron rays. According to a particular embodiment of the present invention, a membrane is irradiated with a radiation dose in the range of 1 to 300 kGy, preferably 3 to 200 kGy and very particularly preferably 20 to 100 kGy.

The polymerisation of the monomers comprising phosphonic acid groups and/or sulphonic acid groups or the cross-linking monomers, respectively, preferably takes place at temperatures of more than room temperature (20° C.) and less than 200° C., in particular at temperatures between 40° C. and 150° C., particularly preferably between 50° C. and 120° C. The polymerisation is preferably performed at normal pressure, but can also be carried out with action of pressure. The polymerisation leads to a solidification of the flat structure, wherein this solidification can be observed via measuring the microhardness. Preferably, the increase in hardness caused by the polymerisation is at least 20%, based on the hardness of a correspondingly hydrolysed membrane without polymerisation of the monomers.

According to a particular aspect of the present invention, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups is preferably greater than or equal to 1:2, in particular greater than or equal to 1:1 and particularly preferably greater than or equal to 2:1.

Preferably, the molar ratio of the molar sum of phosphoric acid, polyphosphoric acid and the hydrolysis products of polyphosphoric acid to the number of moles of the phosphonic acid groups and/or sulphonic acid groups in the polymers obtainable by polymerisation of monomers comprising phosphonic acid groups and/or monomers comprising sulphonic acid groups lies in the range of 1000:1 to 3:1, in particular 100:1 to 5:1 and particularly preferably 50:1 to 10:1.

The molar ratio can be determined by means of customary methods. To this end, especially spectroscopic methods, for example, NMR spectroscopy can be used. In this connection, it has to be considered that the phosphonic acid groups are present in the formal oxidation stage 3 and the phosphorus in phosphoric acid, polyphosphoric acid or hydrolysis products thereof, respectively, in oxidation stage 5.

Depending on the degree of polymerisation desired, the flat structure which is obtained after polymerisation is a self-supporting membrane. Preferably, the degree of polymerisation is at least 2, in particular at least 5, particularly preferably at least 30 repeating units, in particular at least 50 repeating units, very particularly preferably at least 100 repeating units. This degree of polymerisation is determined via the number average of the molecular weight Mₙ, which can be determined by means of GPC methods. Due to the problems of isolating the polymers comprising phosphonic acid groups contained in the membrane without degradation, this value is determined by means of a sample which is obtained by polymerisation of monomers comprising phosphonic acid groups without addition of polymer. In this connection, the weight proportion of monomers comprising phosphonic acid groups and of radical starters in comparison to the ratios of the production of the membrane is kept constant. The conversion achieved in a comparative polymerisation is preferably greater than or equal to 20%, in particular greater than or equal to 40% and particularly preferably greater than or equal to 75%, based on the monomers comprising phosphonic acid groups used.

The hydrolysis fluid comprises water wherein the concentration of the water generally is not particularly critical.

According to a particular aspect of the present invention, the hydrolysis fluid comprises 5 to 80% by weight, preferably 8 to 70% by weight and particularly preferably 10 to 50% by weight, of water. The amount of water which is formally included in the oxo acids is not taken into account in the water content of the hydrolysis fluid.

Of the above-mentioned acids, phosphoric acid and/or sulphuric acid are particularly preferred wherein these acids comprise in particular 5 to 70% by weight, preferably 10 to 60% by weight and particularly preferably 15 to 50% by weight, of water.

The partial hydrolysis of the polyphosphoric acid in step D) leads to a solidification of the membrane due to a sol-gel transition. This is also connected with a reduction in the layer thickness to 15 to 3000 μm, preferably between 20 and 2000 μm, in particular between 20 and 1500 μm; the membrane is self-supporting. The intramolecular and intermolecular structures (interpenetrating networks IPN) present in the polyphosphoric acid layer in accordance with step B) lead to an ordered membrane formation in step C), which is responsible for the particular properties of the membrane formed.

The upper temperature limit for the treatment in accordance with step D) is typically 150° C. With extremely short action of moisture, for example from overheated steam, this steam can also be hotter than 150° C. The duration of the treatment is substantial for the upper limit of the temperature.

The partial hydrolysis (step D) can also take place in climatic chambers where the hydrolysis can be specifically controlled with defined moisture action. In this connection, the moisture can be specifically set via the temperature or saturation of the surrounding area in contact with it, for example gases such as air, nitrogen, carbon dioxide or other suitable gases, or steam. The duration of the treatment depends on the parameters chosen as aforesaid.

Furthermore, the duration of the treatment depends on the membrane thicknesses.

Typically, the duration of the treatment amounts to between a few seconds to minutes, for example with the action of overheated steam, or up to whole days, for example in the open air at room temperature and low relative humidity. Preferably, the duration of the treatment is between 10 seconds and 300 hours, in particular 1 minute to 200 hours.

If the partial hydrolysis is performed at room temperature (20° C.) with ambient air having a relative humidity of 40-80%, the duration of the treatment is between 1 and 200 hours.

The membrane obtained in accordance with step D) can be formed in such a way that it is self-supporting, i.e. it can be detached from the support without any damage and then directly processed further, if applicable.

The concentration of phosphoric acid and therefore the conductivity of the polymer membrane can be set via the degree of hydrolysis, i.e. the duration, temperature and ambient humidity. The concentration of the phosphoric acid is given as mole of acid per mole of repeating unit of the polymer. Membranes with a particularly high concentration of phosphoric acid can be obtained by the method comprising the steps A) to D). A concentration (mol of phosphoric acid, based on a repeating unit of formula (I), for example polybenzimidazole) of 10 to 50, in particular between 12 and 40 is preferred. Only with very much difficulty or not at all is it possible to obtain such high degrees of doping (concentrations) by doping polyazoles with commercially available orthophosphoric acid.

According to a modification of the method described wherein doped polyazole films are produced by use of polyphosphoric acid, the production of these films can be carried out by a method comprising the following steps:
1) reacting one or more aromatic tetramino compounds with one or more aromatic carboxylic acids or their esters, which contain at least two acid groups per carboxylic acid monomer, or one or more aromatic and/or heteroaromatic diaminocarboxylic acids in the melt at temperatures of up to 350° C., preferably up to 300° C.,
2) dissolving the solid prepolymer obtained in accordance with step 1) in polyphosphoric acid,
3) heating the solution obtainable in accordance with step 2) under inert gas to temperatures of up to 300° C., preferably up to 280° C., with formation of the dissolved polyazole polymer,
4) forming a membrane using the solution of the polyazole polymer in accordance with step 3) on a support and
5) treating the membrane formed in step 4) until it is self-supporting.

The steps of the method described under items 1) to 5) have been explained before in detail for the steps A) to D), where reference is made thereto, in particular with regard to preferred embodiments.

A membrane, particularly a membrane based on polyazoles, can further be cross-linked at the surface by action of heat in the presence of atmospheric oxygen. This hardening of the membrane surface further improves the properties of the membrane. To this end, the membrane can be heated to a temperature of at least 150° C., preferably at least 200° C. and particularly preferably at least 250° C. In this step of the method, the oxygen concentration usually is in the range of 5 to 50% by volume, preferably 10 to 40% by volume; however, this should not constitute a limitation.

The cross-linking can also take place by action of IR or NIR (IR=infrared, i.e. light having a wavelength of more than 700 nm; NIR=near-IR, i.e. light having a wavelength in the range of from about 700 to 2000 nm and an energy in the range of from about 0.6 to 1.75 eV), respectively. Another method is β-ray irradiation. In this connection, the irradiation dose is from 5 to 200 kGy.

Depending on the degree of cross-linking desired, the duration of the cross-linking reaction can be within a wide range. In general, this reaction time lies in the range of 1 second to 10 hours, preferably 1 minute to 1 hour; however, this should not constitute a limitation.

Particularly preferred polymer membranes display a high performance. The reason for this is in particular an improved proton conductivity. This is at least 1 mS/cm, preferably at least 2 mS/cm, in particular at least 5 mS/cm at temperatures of 120° C. Here, these values are achieved without moistening.

The specific conductivity is measured by means of impedance spectroscopy in a 4-pole arrangement in potentiostatic mode and using platinum electrodes (wire, diameter of 0.25 mm). The gap between the current-collecting electrodes is 2 cm. The spectrum obtained is evaluated using a simple model comprised of a parallel arrangement of an ohmic resistance and a capacitor. The cross section of the sample of the membrane doped with phosphoric acid is measured immediately prior to mounting of the sample. To measure the temperature dependency, the measurement cell is brought to the desired temperature in an oven and regulated using a Pt-100 thermocouple arranged in the immediate vicinity of the sample. Once the temperature is reached, the sample is held at this temperature for 10 minutes prior to the start of measurement.

### Gas Diffusion Layer

The membrane electrode assembly according to the invention has two gas diffusion layers which are separated by the polymer electrolyte membrane.

Mechanically stabilizing materials which are very light, not necessarily electrically conductive, but mechanically stable and contain fibres, for example, in the form of non-woven fabrics, paper or woven fabrics are used as the starting material for the gas diffusion layers according to the invention. These include, for example, graphite-fibre paper, carbon-fibre paper, graphite fabric and/or paper which was rendered conductive by addition of carbon black. Through these layers, a fine distribution of the flows of gas and/or liquid is achieved.

The mechanically stabilizing material preferably contains carbon fibres, glass fibres or fibres containing organic polymers, for example polypropylene, polyester (polyethylene terephthalate), polyphenylenesulphide or polyether ketones, to name only a few. In this connection, materials with a weight per unit area <150 g/m², preferably with a weight per unit area in the range of 10 to 100 g/m² are particularly well suited.

When using carbon materials as stabilizing materials, non-woven fabrics made of carbonised or graphitised fibres with weights per unit area within the preferred range are particularly suited. Using such materials has two advantages: Firstly, they are very light and secondly, they have a high open porosity. The open porosity of the stabilizing materials used with preference is within the range of 20 to 99.9%, preferably 40 to 99%, such that they can easily be filled with other materials and the porosity, conductivity and hydrophobicity of the finished gas diffusion layer thus can be adjusted in a directed manner, namely throughout the entire thickness of the gas diffusion layer.

Generally, this layer has a thickness in the range of 80 μm to 2000 μm, in particular 100 μm to 1000 μm and particularly preferably 150 μm to 500 μm.

The production of gas diffusion layers or gas diffusion electrodes is described in detail in WO 97/20358, for example. The production methods set out therein are also part of the present description.

To reduce the surface tension, materials (additives or detergents) can be added, such as described in detail in WO 97/20358. Additionally, the hydrophobicity of the gas diffusion layer can be set by using perfluorinated polymers together with non-fluorinated binders. Subsequently, the equipped gas diffusion layers are dried and after-treated thermally, for example by sintering at temperatures of more than 200° C.

Furthermore, it is possible to construct the gas diffusion layer with several layers. In a preferred embodiment of the gas diffusion layer, it has at least 2 distinguishable layers. 4 layers are considered as an upper limit for multi-layered gas diffusion layers. If more than one layer is used, it is convenient to form an intimate connection of these layers with each other by means of a compression or lamination step, preferably at a higher temperature. By using multi-layered gas diffusion layers, it is possible to produce pre-trimmed layers, by means of which gradients of effective porosity and/or hydrophobicity can be set. Such gradients can also be generated by several successive coating or impregnating steps which, however, is typically more elaborate to implement.

According to a particular embodiment, at least one of the gas diffusion layers can consist of a compressible material. Within the scope of the present invention, a compressible material is characterized by the property that the gas diffusion layer can be compressed to half, in particular a third of its original thickness without losing its integrity.

The gas diffusion layers according to the invention have a low electrical surface resistivity which is in the range of <100 mOhm per cm², preferably <60 mOhm per cm².

This property is generally exhibited by a gas diffusion layer made of graphite fabric and/or graphite paper which were rendered conductive by addition of carbon black. The gas diffusion layers are usually also optimised in respect of their hydrophobicity and mass transfer properties by the addition of further materials. In this connection, the gas diffusion layers are equipped with fluorinated or partially fluorinated materials, for example PTFE.

### Catalyst Layer

The catalyst layer or catalyst layers contains or contain catalytically active substances. These include, amongst others, precious metals of the platinum group, i.e. Pt, Pd, Ir, Rh, Os, Ru, or also the precious metals Au and Ag. Furthermore, alloys of all the above-mentioned metals may also be used. Additionally, at least one catalyst layer can contain alloys of the elements of the platinum group with non-precious metals, such as for example Fe, Co, Ni, Cr, Mn, Zr, Ti, Ga, V, etc. Furthermore, the oxides of the above-mentioned precious metals and/or non-precious metals can also be used.

The catalytically active particles which comprise the above-mentioned substances can be used as metal powder, in particular platinum and/or platinum alloy powder, so-called black precious metal. Such particles generally have a size in the range of 5 nm to 200 nm, preferably in the range of 7 nm to 100 nm. So-called nano particles are also used.

Furthermore, the metals can also be used on a support material. Preferably, this support comprises carbon which particularly may be used in the form of carbon black, graphite or graphitised carbon black. Furthermore, electrically conductive metal oxides, such as for example, SnOₓ, TiOₓ, or phosphates, such as e.g. FePOₓ, NbPOₓ, Zr_{y}(POₓ)_{z}, can be used as support material. In this connection, the indices x, y and z designate the oxygen or metal content of the individual compounds which can lie within a known range as the transition metals can be in different oxidation stages.

The content of these metal particles on a support, based on the total weight of the bond of metal and support, is generally in the range of 1 to 80% by weight, preferably 5 to 60% by weight and particularly preferably 10 to 50% by weight; however, this should not constitute a limitation. The particle size of the support, in particular the size of the carbon particles, is preferably in the range of 20 to 1000 nm, in particular 30 to 100 nm. The size of the metal particles present thereon is preferably in the range of 1 to 20 nm, in particular 1 to 10 nm and particularly preferably 2 to 6 nm.

The sizes of the different particles represent mean values and can be determined via transmission electron microscopy or X-ray powder diffractometry.

The catalytically active particles set forth above can generally be obtained commercially.

Besides the catalysts or catalyst particles already commercially available, catalyst nano particles made of platinum-containing alloys, in particular based on Pt, Co and Cu or Pt, Ni and Cu, respectively, can also be used in which the particles in the outer shell have a higher Pt content as in the core. Such particles were described by P. Strasser et al. in Angewandte Chemie 2007.

Furthermore, the catalytically active layer may contain customary additives. These include, amongst others, fluoropolymers, such as e.g. polytetrafluoroethylene (PTFE), proton-conducting ionomers and surface-active substances.

According to a particular embodiment of the present invention, the weight ratio of fluoropolymer to catalyst material comprising at least one noble metal and optionally one or more support materials is greater than 0.1, this ratio preferably lying within the range of 0.2 to 0.6.

According to a particular embodiment of the present invention, the catalyst layer has a thickness in the range of 1 to 1000 μm, in particular from 5 to 500, preferably from 10 to 300 μm. This value represents a mean value, which can be determined by using cross-section images of the layer that can be obtained with a scanning electron microscope (SEM).

According to a particular embodiment of the present invention, the content of noble metals of the catalyst layer is 0.1 to 10.0 mg/cm², preferably 0.3 to 6.0 mg/cm² and particularly preferably 0.3 to 3.0 mg/cm². These values can be determined by elemental analysis of a flat sample.

The catalyst layer is in general not self-supporting but is usually applied to the gas diffusion layer and/or the membrane. In this connection, a part of the catalyst layer can, for example, diffuse into the gas diffusion layer and/or the membrane, resulting in the formation of transition layers. This can also lead to the catalyst layer being understood as part of the gas diffusion layer. The thickness of the catalyst layer results from measuring the thickness of the layer onto which the catalyst layer was applied, for example the gas diffusion layer or the membrane, the measurement providing the sum of the catalyst layer and the corresponding layer, for example the sum of the gas diffusion layer and the catalyst layer. The catalyst layers preferably feature gradients, i.e. the content of precious metals increases in the direction of the membrane while the content of hydrophobic materials is behaving contrarily.

For further information on membrane electrode assemblies, reference is made to the technical literature, in particular the patent applications WO 01/18894 A2, DE 195 09 748, DE 195 09 749, WO 00/26982, WO 92/15121 and DE 197 57 492. The disclosure contained in the above-mentioned references with respect to the structure and production of membrane electrode assemblies as well as the electrodes, gas diffusion layers and catalysts to be chosen is also part of the description.

### Electrode

If the above-mentioned gas diffusion layers are provided with a catalyst layer on the side facing the polymer electrolyte membrane or electrolyte matrix, this is also referred to as electrode.

Coating of the gas diffusion layers with the catalyst material is performed by known measures, in particular as described in detail in WO 97/20358. The production methods set out therein are also part of the present description.

### Gaskets

The gaskets used or generated within the scope of the method according to the invention are either produced in a separate step and applied or else directly generated on the circumferential edge of the gas diffusion layer and the circumferential, optionally raised edge of the bipolar plate.

In this connection, it is essential that the gasket in the formed, constructional inner boundary area overlaps inwards and thus overlaps the outer boundary area of the gas diffusion layer or the gas diffusion layer provided with a catalyst layer. Through this overlap, the gas diffusion layer is fixed in the bipolar plate such that further positioning or fixing frames can be dispensed with. Additionally, no longer does the boundary area of the gas diffusion layer have to be interspersed with sealing material or does the sealing material have to penetrate the boundary area of the gas diffusion layer to achieve the sealing function.

Furthermore, it is advantageous if the gasket possesses a sufficient mechanical stability and/or integrity such that in a subsequent compression step, for example, the gas diffusion layer and/or the membrane/electrolyte matrix will not be damaged. To this end, a so-called hard stop function may be integrated into the gasket in an advantageous manner. This embodiment is particularly preferred when the gasket is produced on a bipolar plate without a raised edge.

Production of the gasket can be performed in a separate step or else the gasket is generated directly on the circumferential edge of the gas diffusion layer towards the bipolar plate. Formation of the gasket can be performed by means of all the known methods, preferably by the spray-application of thermoplastic elastomers or cross-linkable rubbers or the application and/or cross-linking of these by means of printing methods.

Preferably, the gaskets according to the invention are formed from meltable polymers or rubbers which can be processed thermally.

Among the rubbers, silicone rubber (O), ethylene-propylene-diene rubber (EPDM), ethylene-propylene rubber (EPM), isobutylene-isoprene rubber (IIR), butadiene rubber (BR), styrene-butadiene rubber (SBR), styrene-isoprene rubber (SIR), isoprene-butadiene rubber (IBR), isoprene rubber (IR), acrylonitrile-butadiene rubber (NBR), chloroprene rubber (CR), acrylate rubber (ACM) and/or partially hydrogenated rubber from butadiene rubber (BR), styrene-butadiene rubber (SBR), isoprene-butadiene rubber (IBR), isoprene rubber (IR), acrylonitrile-butadiene rubber (NBR), polyisobutylene rubber (PIB), fluoro rubber (FPM), fluorosilicone rubber (MFQ, FVMQ) are preferred.

Furthermore, fluoropolymers are used as sealing material, preferably poly(tetrafluoroethylene-co-hexafluoropropylene) FEP, polyvinylidene fluoride PVDF, perfluoroalkoxy polymer PFA and poly(tetrafluoroethylene-co-perfluoro(methylvinyl ether) MFA. These polymers are commercially available in many ways, for example under the trade names Hostafon®, Hyflon®, Teflon®, Dyneon® and Nowoflon®.

Apart from the materials mentioned above, sealing materials based on polyimides can also be used. The class of polymers based on polyimides also includes polymers also containing, besides imide groups, amide (polyamideimides), ester (polyesterimides) and ether groups (polyetherimides) as components of the backbone.

Preferred polyimides have recurring units of the formula (VI)

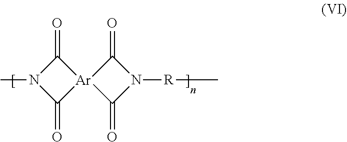

wherein the functional group Ar has the meaning set forth above and the functional group R represents an alkyl group or a bicovalent aromatic or heteroaromatic group with 1 to 40 carbon atoms. Preferably, the functional group R represents a bicovalent aromatic or heteroaromatic group derived from benzene, naphthalene, biphenyl, diphenyl ether, diphenyl ketone, diphenylmethane, diphenyldimethylmethane, bisphenone, diphenylsulphone, quinoline, pyridine, bipyridine, anthracene, thiadiazole and phenanthrene which optionally also can be substituted. The index n suggests that the recurring units represent parts of polymers.

Such polymers are commercially available under the trade names ®Kapton, ®Vespel, ®Toray and ®Pyralin from DuPont as well as ®Ultem from GE Plastics and ®Upilex from Ube Industries.

Combinations of the above-mentioned materials with the property combination soft/hard are also suitable as sealing material, in particular when the above-mentioned hard stop function is to be integrated.

Particularly preferred sealing materials have a Shore A hardness of 5 to 85, in particular of 25 to 80. The Shore hardness is determined according to DIN 53505. Furthermore, it is advantageous when the permanent set of the sealing material is lower than 50%. The permanent set is determined according to DIN ISO 815.

The thickness of the gaskets is influenced by several factors. An essential factor is how high the elevation in the boundary area of the bipolar plate is chosen. Usually, the thickness of the gasket generated or applied is 5 μm to 5000 μm, preferably 10 μm to 1000 μm and in particular 25 μm to 150 μm. In particular in the case of bipolar plates without a raised boundary area, the thickness can also be higher.

The gaskets can also be constructed with several layers. In this embodiment, different layers are connected with each other using suitable polymers, in particular fluoropolymers being well suited to establish an adequate connection. Suitable fluoropolymers are known to those in professional circles. These include, amongst others, polytetrafluoroethylene (PTFE) and poly(tetrafluoroethylene-co-hexafluoropropylene) (FEP). The layer made of fluoropolymers present on the sealing layers described above in general has a thickness of at least 0.5 μm, in particular at least 2.5 μm. If expanded fluoropolymers are applied, the thickness of the layer can be 5 to 250 μm, preferably 10 to 150 μm.

The gaskets or sealing materials described above are such that they fix the gas diffusion layer in the recess which is formed together with the bipolar plate. To this end, it is advantageous when the gasket overlaps the outer boundary area of the gas diffusion layer circumferentially. The overlap of the gasket with the boundary area of the gas diffusion layer is preferably 0.1 to 5 mm, preferably 0.1 to 3 mm, based on the outermost edge of the gas diffusion layer. A greater overlap is possible, but leads to a strong loss in catalytically active surface. For this reason, the degree of overlapping has to be balanced in a critical way so that an unnecessarily excessive part of the catalytically active surface is covered.

Though it is advantageous when the gasket overlaps the boundary area of the gas diffusion layer circumferentially, nonetheless, discontinuities in the overlap of the circumferential sealing edge with the boundary area of the gas diffusion layer can also exist, in particular with respect to the active catalytic surface. In this connection, it is essential that the fixing function of the gas diffusion layer remains ensured through the gasket.

### Bipolar Plates

The bipolar plates or also separator plates used within the scope of the present invention are typically provided with process media channels (flow field channels) to permit the distribution of the reactants and other fluids typical for fuel cells, for example cooling fluids.

The bipolar plates are usually formed from electrically conductive materials; these may be metallic or non-metallic materials.

If the bipolar plates are constructed from non-metallic materials, so-called composite materials are preferred. Composite materials are composites made of a matrix material which are provided with electrically conductive fillers. Polymeric materials, in particular organic polymers are preferably suited as the matrix material. Depending on the operating temperature of the fuel cell, high-performance polymers, in particular thermally stable polymers can also be required. Depending on the field of use, polymers are used whose long-term service temperature is at least 80° C., preferably at least 120° C., particularly preferably at least 180° C.

Thermoplastics, in particular polypropylene (PP), polyvinylidene fluoride (PVDF), polytetrafluoroethylene (PTFE), polyphenylene sulphide (PPS) and liquid-crystalline polymers (LCP) are used with particular preference, it also being possible to use these as compounds, i.e. admixed with other polymers and typical additives, respectively. Besides the thermoplastics, thermosetting plastics and resins are also preferred. In particular, phenol resins (PF), melamine resins (MF), polyester (UP) and epoxy resins (EP) are used.

Particulate substances which permit a distribution as homogenous as possible in the matrix are used as electrically conductive fillers. Preferably, these fillers possess a bulk conductivity of at least 10 mS/cm. Carbons, graphites and carbon blacks are used with particular preference. These can also be treated to achieve a better wettability with the matrix material. The particle size is not subject to any particular limitation, but has to permit the production of such bipolar plates. Apart from the above-mentioned electrically conductive fillers, even further additives which are to improve the application properties can be added to the matrix materials. Fibre reinforcements are also possible, in particular if the mechanical load can otherwise not be ensured.

Producing such bipolar plates is preferably performed by means of suitable forming methods, in particular by means of injection moulding techniques as well as injection embossing and embossing techniques.

Besides the process media ducts, the bipolar plates can also have further ducts or openings or bores through which coolants or reaction gases, for example, can be supplied and discharged.

The thickness of the non-metallic bipolar plates is preferably within the range of 0.3 to 10 mm, in particular within the range of 0.5 to 5 mm and particularly preferably within the range of 0.5 to 2 mm. The conductivity of the non-metallic bipolar plates is greater than or equal to 25 S/cm.

If the bipolar plates are constructed from metallic materials, more cost-efficient integral designs are possible. The construction of such metallic bipolar plates is not subject to any substantial limitation.

Corrosion-resistant and acid-resistant steels are preferred as metallic materials, in particular those based on V2A and V4A steels as well as those made of nickel-based alloys. Plated or coated metals are further preferred, in particular those with corrosion-resistant surfaces made of precious metals, nickel, ruthenium, niobium, tantalum, chromium, carbon as well as metals coated with ceramic materials, in particular coats made of CrN, TiN, TiAlN, complex nitrides, carbides, silicides and oxides of metals and transition metals.

Aside from these, the metallic bipolar plates can additionally have such coats which, on the one hand, reduce the electrical surface resistivity of the junction of gas diffusion layer/bipolar plate or else increase the chemical and/or physical resistance of the bipolar plate towards the media present or formed in fuel cells.

The construction of metallic bipolar plates can take place from individual plates, it thus being possible in a simple manner to form voids for coolants or reaction media which have to be supplied and discharged. The connection of the individual plates can be performed by material bonding methods, such as, for example, welding or soldering. If necessary, the voids are additionally sealed with respect to each other, e.g. by means of further internal coats such that leakages can be avoided.

If fuel cell systems free of cooling layers are constructed or such systems in which several individual cells of the fuel cell stack do not require any cooling, the bipolar plates or individual bipolar plates in the stack may also be manufactured from only one metallic or non-metallic individual plate.

The construction and production of suitable metallic bipolar plates are described in detail in DE-A-10250991, WO 2004/036677, WO 2004/105164, WO 2005/081614, WO 2005/096421 and WO 2006/037661. The assemblies and production methods set out therein are also part of the present invention and description.

The thickness of the metallic bipolar plates is preferably within the range of 0.03 to 1 mm, in particular within the range of 0.05 to 0.5 mm and particularly preferably within the range of 0.05 to 0.15 mm.

The bipolar plates used within the scope of the present invention may have a raised boundary area such that the area of the bipolar plate containing the channels of the flow field forms a recess. The exact height of the boundary area in relation to the highest elevation of the area of the bipolar plate having the process media channels is adapted to the thickness of the gas diffusion layer or the gas diffusion layer with a catalyst layer. If the gas diffusion layer or the gas diffusion layer with a catalyst layer is not to be subjected to any further compression during the subsequent compression step, the elevation of the boundary area of the bipolar plate corresponds to the thickness of the gas diffusion layer or the gas diffusion layer with a catalyst layer.

If the thickness of the gas diffusion layer or the gas diffusion layer with a catalyst layer is higher than the height of the boundary area opposite the highest elevation of the area of the bipolar plate having the process media ducts, a compression of the gas diffusion layer results during the subsequent compression step. The degree of compression is determined via the thickness and formability of the sealing material such that the sealing material acts as a hard stop. This embodiment is particularly advantageous when soft or easily formable polymer electrolyte membranes are used as damage to the membrane can be avoided.

It has been found that it is advantageous to design the elevation of the boundary area or the elevation through the frame-shaped component in such a way that the gas diffusion layer or the gas diffusion layer with a catalyst layer experiences a compression of at least 3% compared to the original thickness. Particularly preferably, the above-described elevation of the boundary area is chosen such that the compression is at least 5%. A compression of more than 50%, in particular of more than 30% is chosen as the upper limit, it being possible to also exceed this through the choice of other parameters.

The compression of the components in accordance with step e) or f) of the method is performed by the action of pressure and temperature such that an intimate connection of the components with each other is formed. In general, this is carried out at a temperature in the range of 10 to 300° C., in particular 20° C. to 200° C. and with a pressure in the range of 1 to 1000 bar, in particular of from 3 to 300 bar.

The above-mentioned compression can also take place during the production of the stack and/or when starting-up the fuel cell stack. After step c), the electrochemical cell, in particular individual cell for fuel cells is operational and can be used. To produce a fuel cell stack, the underlying individual cells for fuel cells are arranged as a stack. Furthermore, the production of the fuel cell stack can be performed by using the semi-finished parts according to the invention, it being possible to provide these beforehand with the required membrane. In this connection, the membrane is previously available as rolled goods, for example, and can be cut individually to be adapted to the respective bipolar plate design, with minimal use of materials. No handling frame needs to be added. The production of fuel cell stacks from individual cells for fuel cells is generally known.

The present invention will be explained in more detail below on the basis of some examples, without this being intended to represent any limitation.

In this connection:

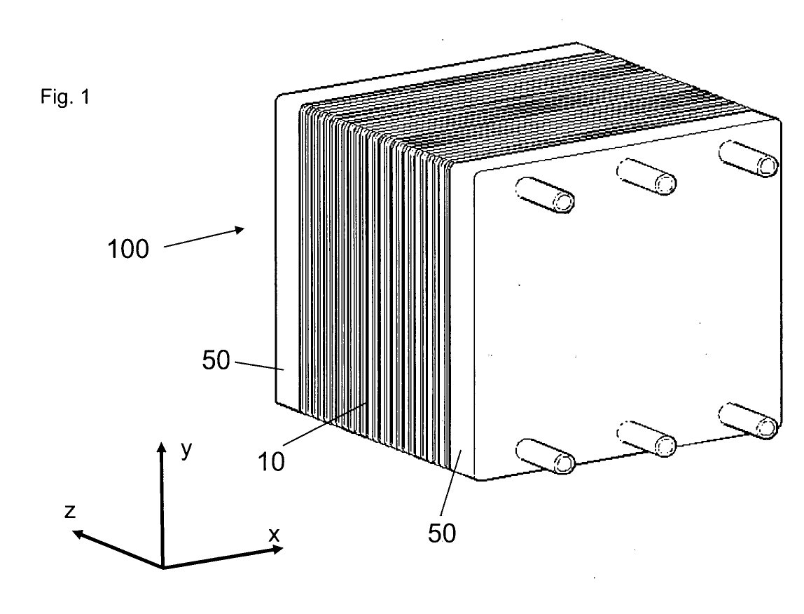

FIG. 1 shows a fuel cell stack,

FIG. 2 shows the setup of a fuel cell arrangement in a exploded assembly drawing,

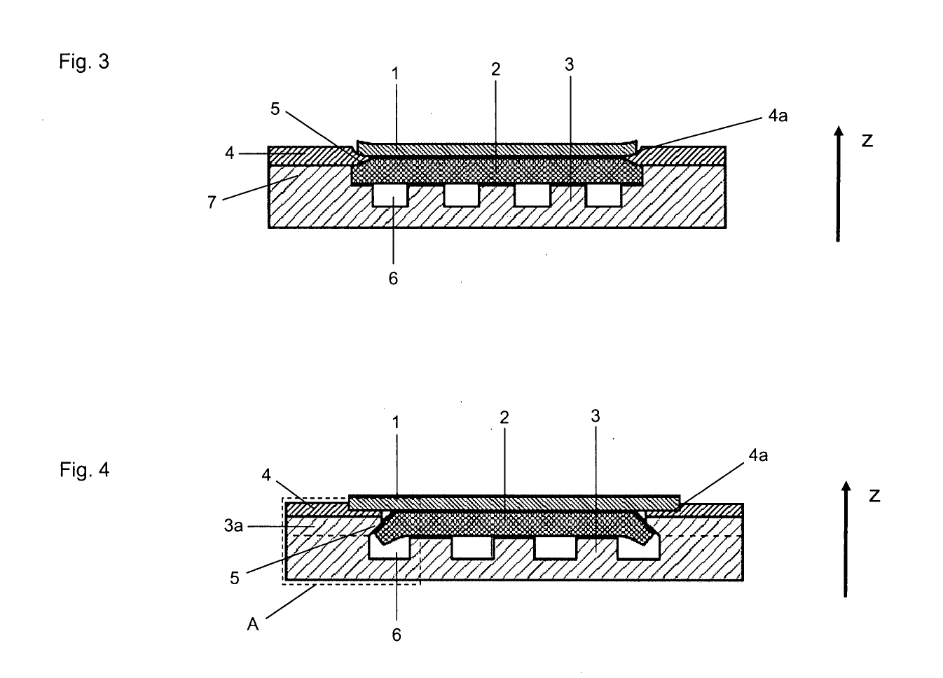

FIG. 3 shows a cross-section through a semi-finished part produced by means of the method according to the invention,

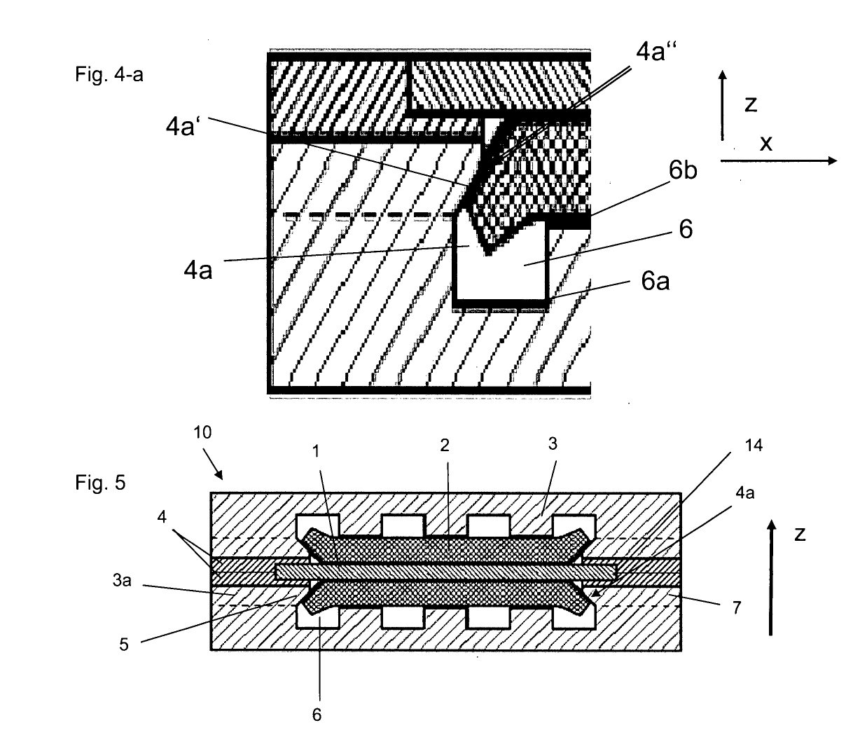

FIG. 4 shows a cross-section through another semi-finished part produced by means of the method according to the invention,

FIG. 4-a shows a detailed view to section A of FIG. 4, and

FIG. 5 shows a cross-section through another semi-finished part produced by means of the method according to the invention.

FIG. 1 shows a fuel cell stack 100 which is consists of a multitude of fuel cells 10 as well as two end plates 50 at both termini. In FIG. 1 a coordinate system is depicted which facilitates understanding of the following figures.

FIG. 2 shows the essential components of a fuel cell 10, namely two bipolar plates (3), a gas diffusion layer (2) and a polymer electrolyte membrane (1). The second gas diffusion layer is covered by the membrane and not visible in this drawing. In the bipolar plates, process media channels are given which form the flow field (6). FIG. 2 shows the usual order in which the components are arranged in the state of the art. The coordinate system indicates that the components are shown in the same direction as in FIG. 1.

FIG. 3 shows a cross-section through a semi-finished part produced by means of the method according to the invention. The arrow indicates that the point of view has changed with respect to the one in FIGS. 1 and 2. The bipolar plate (3) provided with channels (6) of the flow field has a circumferential edge (7) raised with respect to the flat area of the bipolar plate having the channels (6) of the flow field. The channels (6) of the flow field are covered by a gas diffusion layer (2). In this connection, the gas diffusion layer (2) is laterally enclosed by the circumferential, raised edge (7) of the bipolar plate and fixed in the horizontal direction. The gas diffusion layer (2) may have a catalyst layer on the side facing the polymer electrolyte membrane (1) or electrolyte matrix (1), the catalyst layer not being shown explicitly. If a polymer electrolyte membrane (1) or electrolyte matrix (1) provided with a catalyst layer is used, the gas diffusion layer must not necessarily have a catalyst layer. In this embodiment, the circumferential constructional element (4) is formed as a gasket and applied to the raised edge (7) of the bipolar plate. According to the invention, the applied gasket (4) projects from the raised edge (7) in its horizontal dimension towards the flat area of the bipolar plate. In the opposite direction, the applied gasket must not necessarily be flush with the outer edge of the bipolar plate. Through this, the circumferential constructional element (4), the raised edge (7) of the bipolar plate and the flat area of the bipolar plate form a recess in the form of an undercut (5). The gasket (4) thus, according to its task, overlaps the boundary area of the gas diffusion layer (2) and additionally fixes the gas diffusion layer in its outer boundary area in the vertical direction. The circumferential constructional element (4) features a cavity (4a) in the inner area to receive the polymer electrolyte membrane (1) or electrolyte matrix (1). In this connection, the shape of the cavity is chosen such that the cavity forms an enclosure for the polymer electrolyte membrane (1) or electrolyte matrix (1) into which the membrane (1) can be inserted. In this connection, it has to be ensured that the height of the membrane (1) projects from the upper edge of the enclosure such that sufficient compression of the membrane (1) is guaranteed when joining several semi-finished parts to a fuel cell stack.

FIG. 4 shows a cross-section through another semi-finished part produced by means of the method according to the invention. The bipolar plate (3) provided with channels of the flow field has no raised edge. The channels of the flow field are covered by a gas diffusion layer (2). The gas diffusion layer (2) may have a catalyst layer on the side facing the polymer electrolyte membrane (1) or electrolyte matrix (1), the catalyst layer not being shown explicitly. If a polymer electrolyte membrane (1) or electrolyte matrix (1) provided with a catalyst layer is used, the gas diffusion layer must not necessarily have a catalyst layer. The circumferential constructional element (3a) is formed as a frame and consists of a material compatible with the material of the bipolar plate, preferably the same material. This is indicated by the dashed line between bipolar plate (3) and the constructional element (3a). After applying the gas diffusion layer (2) to the flat area of the bipolar plate being provided with the process media ducts, the constructional element (3a) is applied to the boundary area of the bipolar plate. In this connection, the circumferential constructional element (3a) is constructed in such a way that it has a projection or a recess (5) in its horizontal dimension towards the flat area of the bipolar plate. Through this, after applying it to the bipolar plate in the projection area, the circumferential constructional element overlaps the boundary area of the gas diffusion layer (2) and additionally fixes the gas diffusion layer in its outer boundary area in the vertical direction. The circumferential, frame-shaped constructional element (3a) is provided with a circumferential gasket (4) which features a cavity (4a) in the inner area to receive the polymer electrolyte membrane (1) or electrolyte matrix (1). In this connection, the shape of the cavity is chosen such that the cavity forms an enclosure for the polymer electrolyte membrane (1) or electrolyte matrix (1) into which the membrane (1) can be inserted. In this connection, it has to be ensured that the height of the membrane (1) projects from the upper edge of the enclosure such that sufficient compression of the membrane (1) is guaranteed when joining several semi-finished parts to a fuel cell stack.

FIG. 4-a shows a detail of the cross-section of FIG. 4, namely the section highlighted by the rectangle A. It there and from FIGS. 3 and 4 becomes obvious that the cavity (4a) has such a shape that when considering its upper side (4a′) in a vector decomposition, it needs to have one component x that runs parallel to the surface of the bottom (6a) of the channels (6) in the flow field. It optionally has a component z that runs orthogonal to x. If this component z is given, the upper side (4a′) of the cavity (4a) is shaped in such a way that its open end (4a″) points away from the channel bottom. Moreover, in order not to damage the GDL/GDE, the upper side (4a′) may have no sharp edge but rather be rounded or at least smooth. This slope in the upper wall (4a′) of the cavity (4a) together with the lands (6b) of the flow field allows to put the GDL/GDE under a pre-tension.

FIG. 5 finally shows a cross section through another semi-finished part produced by means of the method according to the invention. In contrast to the examples of FIGS. 3 and 4, here a complete fuel cell (10) is obtained by putting assembling two semi-finished parts according to FIGS. 3 and 4. Each bipolar plate (3) on its outer edge has a raised edge (7) with a gasket (4). The GDL/GDE (2) of the two parts assembled has already been fixed in the respective cavity (4a) before this assembly and therefore need no special treatment during the assembly. In the assembly, a groove (14) is formed which takes up the edges of the polymer electrolyte matrix (1) or polymer electrolyte membrane (1).

1.-23. (canceled)

24. A method for the production of an electrochemical cell, the cell including
(i) at least one proton-conducting polymer electrolyte membrane or electrolyte matrix,
(ii) at least one catalyst layer which in each case is arranged on both sides of the proton-conducting polymer electrolyte membrane or electrolyte matrix,
(iii) at least one electrically conductive gas diffusion layer which in each case is arranged on that side of the catalyst layer facing away from the electrolyte,
(iv) at least one bipolar plate with integrated channels of a flow field which in each case is arranged on those sides of the gas diffusion layer facing away from the catalyst layer,
(v) at least one circumferential constructional element in a boundary area of the gas diffusion layer towards the bipolar plate,
the method comprising:
a) supplying a bipolar plate provided with channels of the flow field,
b) supplying a gas diffusion layer or a gas diffusion layer which has at least one catalyst layer on that side facing away from the bipolar plate and depositing the gas diffusion layer on that part of the bipolar plate provided with the channels of the flow field such that the channels for the process media are completely covered by the gas diffusion layer,
c) producing or attaching a circumferential constructional element on the edge or boundary area of the bipolar plate,
d) supplying and depositing a proton-conducting polymer electrolyte membrane or electrolyte matrix on the surface of the gas diffusion layer or on the catalyst layer applied to the gas diffusion layer,
e) compressing the component obtained in accordance with step d) with another component which has a bipolar plate, a gas diffusion layer, optionally a catalyst layer and a circumferential constructional element in the boundary area of the bipolar plate and was likewise produced in accordance with steps a), b) and c),
wherein the circumferential constructional element produced or attached in accordance with step c) in its constructional inner boundary area projects from the latter and overlaps the outer boundary area of the gas diffusion layer or the gas diffusion layer provided with a catalyst layer and fixes the latter in the recess which has the form of an undercut and is formed by the circumferentially attached constructional element projecting from the inner boundary area and by the bipolar plate.

25. The method according to claim 24, wherein the circumferential constructional element is a component formed in the shape of a frame which projects in its constructional inner area from the latter and at least partially overlaps the gas diffusion layer or the gas diffusion layer provided with a catalyst layer and fixes the gas diffusion layer in the recess which is formed by the bipolar plate and the circumferential, frame-shaped component.

26. The method according to claim 24, wherein the circumferential constructional element is formed from a sealing material, in particular based on polymers, or else from a material compatible with the material of the bipolar plate, in particular from the same material as the bipolar plate.

27. The method according to claim 24, wherein the circumferential constructional element in (v) is composed of a sealing material, in particular based on polymers, and the bipolar plate has a circumferential edge raised opposite the flat area of the bipolar plate having the channels.

28. The method according to claim 27, wherein the surface of the circumferential, raised edge and the surface of the flat area of the bipolar plate with the channels of the flow field are arranged essentially parallel to each other.

29. The method according to claim 26, wherein the gasket features a recess in the inner boundary area to receive the proton-conducting polymer electrolyte membrane or electrolyte matrix.

30. The method according to claim 26, wherein the circumferential, frame-shaped component is formed from a material compatible with the material of the bipolar plate, in particular from the same material as the bipolar plate, and an applied circumferential gasket covers the circumferential, frame-shaped component.

31. The method according to claim 30, wherein the gasket present on the circumferential, frame-shaped component features a recess in the inner boundary area to receive the proton-conducting polymer electrolyte membrane or electrolyte matrix.

32. The method according to claim 24, wherein the electrolyte matrix has at least one ion-conducting material and at least one matrix.

33. The method according to claim 24, wherein the proton-conducting polymer electrolyte membrane comprises acids wherein the acids (i) may be covalently bound to polymers or (ii) may be bound to polymers by ionic interactions.

34. The method according to claim 24, wherein the bipolar plate is formed from electrically conductive materials.

35. The method according to claim 34, wherein the bipolar plate is formed from metallic or non-metallic materials.

36. The method according to claim 35, wherein the bipolar plate formed from non-metallic material comprises composite materials.

37. The method according to claim 36, wherein the at least one composite material consists of one or more polymeric materials and comprises electrically conductive fillers.

38. The method according to claim 35, wherein the bipolar plate formed from metallic material comprises (i) corrosion-resistant and acid-resistant steels, in particular based on V2A and V4A steels as well as made of nickel-based alloys, (ii) plated or coated metals, in particular those with corrosion-resistant surfaces made of precious metals, nickel, ruthenium, niobium, tantalum, chromium, carbon as well as (iii) metals coated with ceramic materials, in particular coats made of CrN, TiN, TiAlN, complex nitrides, carbides, silicides and oxides of metals and transition metals.

39. The method according to claim 35, wherein the bipolar plate formed from metallic material has one or more additional coats which, on the one hand, reduce the electrical surface resistivity of the junction of gas diffusion layer/bipolar plate or else increase the chemical and/or physical resistance of the bipolar plate towards the media present or formed in fuel cells.

40. The method according to claim 35, wherein the bipolar plate is constructed from one or more individual plates and has voids for coolants or for the supply and discharge of reaction gases.

41. An electrochemical cell comprising:
(i) at least one proton-conducting polymer electrolyte membrane or electrolyte matrix,
(ii) at least one catalyst layer which in each case is arranged on both sides of the proton-conducting polymer electrolyte membrane or electrolyte matrix,
(iii) at least one electrically conductive gas diffusion layer which in each case is arranged on that side of the catalyst layer facing away from the electrolyte,
(iv) at least one bipolar plate with integrated channels of the flow field which in each case is arranged on those sides of the gas diffusion layer facing away from the catalyst layer,
(v) at least one circumferential constructional element in the boundary area of the gas diffusion layer towards the bipolar plate,
wherein the constructional element projects in its constructional inner boundary area from the latter and overlaps the outer boundary area of the gas diffusion layer or the gas diffusion layer provided with a catalyst layer and fixes it in the recess which has the form of an undercut and is formed by the circumferential constructional element and the bipolar plate.

42. A fuel cell stack containing more than one individual cell for fuel cells according to claim 41.

43. A fuel cell system containing at least one individual cell for fuel cells according to claim 41.

44. A semi-finished part comprising:
I) at least one bipolar plate with integrated channels of the flow field, and
II) at least one electrically conductive gas diffusion layer which covers the channels of the flow field of the bipolar plate completely,
III) the bipolar plate in each case being arranged on those sides of the gas diffusion layer facing away from the catalyst layer,
characterized in that the bipolar plate has a constructional element circumferential in the boundary area which projects in its constructional inner boundary area from the latter and overlaps the outer boundary area of the gas diffusion layer or the gas diffusion layer provided with a catalyst layer and fixes it in the recess which has the form of an undercut and is formed by the circumferential constructional element and the bipolar plate.

45. The semi-finished parts according to claim 44, wherein the overlap in the constructional inner boundary area is not continuously circumferential and features gaps.

46. The use of the semi-finished parts according to claim 44 for the production of electrochemical cells, in particular individual cells for fuel cells.
